(19) United States
(12) Patent Application Publication
(10) Pub. No.: US 2007/0104931 A1
(43) Pub. Date: May 10, 2007

(54) Heat-shrinkable polyester film and heat-shrinkable polyester film roll

(75) Inventors: Hideki Ito, Inuyama-shi (JP); Norimi Tabota, Inuyama-shi (JP); Hisanobu Oda, Inuyama-shi (JP)

Correspondence Address: KENYON & KENYON LLP, 1500 K STREET N.W., SUITE 700, WASHINGTON, DC, 20005, US

(73) Assignee: TOYO BOSEKI KABUSHIKI KAISHA, Osaka (JP)

(21) Appl. No.: 10/576,478

(22) PCT Filed: Oct. 20, 2004
(86) PCT No.: PCT/JP04/15859

§ 371 Date: Apr. 20, 2006

(30) Foreign Application Priority Data
Oct. 21, 2003 (JP) 2003-361084
Oct. 22, 2003 (JP) 2003-362192
Oct. 24, 2003 (JP) 2003-364532

(51) Int. Cl. B32B 27/32

(52) U.S. Cl. 428/220

(57) ABSTRACT

Provided is a heat-shrinkable polyester film satisfying: (A) a heat shrinkage percentage of 10% to 50% in a maximum shrinkage direction in a hot water at 70° C., (B) a heat shrinkage percentage of not less than 75% in a maximum shrinkage direction, and not more than 10% in an orthogonal to the maximum shrinkage direction in a hot water at 85° C.,
(C) a heat shrinkage percentage difference ΔX(%)=X₀−X₁₀ of a sample is 10% to 20%,
wherein, X₀ and X₁₀ are defined as follows,
X₀(%): a heat shrinkage percentage in a maximum shrinkage direction in a hot water at 95° C.; and
X₁₀(%): a heat shrinkage percentage in a maximum shrinkage direction of a film having experienced heat shrink by 10% in a maximum shrinkage direction; (D) a three-dimensional surface roughness Δa gives 0.008 to 0.04; and (E) a three-dimensional surface roughness SRz gives 0.6 to 1.5 micrometers. Even in use for full label usage, the heat-shrinkable polyester film has excellent quality after shrink-finishing, reinforcement function of containers after wrapped by shrinking, and blocking resistance, and furthermore exhibits excellent film-formation property, and processability as well. In addition, the present invention provides a heat-shrinkable polyester film having ultraviolet absorptivity, and a heat-shrinkable polyester film roll exhibiting uniform heat shrinkage properties over whole of a long film.

### TECHNICAL FIELD

The present invention relates to heat-shrinkable polyester film suitable for label usage and to a film roll obtained by winding up a long heat-shrinkable polyester film. A heat-shrinkable polyester film of the present invention has outstanding heat shrinkage properties. In addition, a heat-shrinkable polyester film wound up into a film roll of the present invention gives a fewer incidence of defective products in production processes of products such as labels, bags etc., and also a distinctly fewer incidence of defects such as insufficient shrinkage, shrinkage shading, whitening, crinkling, deformation, uneven shrinkage in the direction orthogonal to the maximum shrinkage direction in the heat shrinking process.

### BACKGROUND ART

Conventionally, heat-shrinkable polyester films (hereinafter, occasionally referred to only as a film) have been widely used as shrink (accumulative) packaging products, shrink labels, cap seals, etc., for a variety of containers such as polyethyleneterephthalate (PET) containers, polyethylene containers, glass containers, utilizing heat shrinkable property thereof.

Especially, in these days, use of colored PET bottle is being limited from a viewpoint of recycling, and therefore increasing are demands of covering of most of a bottle side surface with a label of a heat-shrinkable polyester film instead of coloring of the bottle itself, (what is called full label usage). Whereas, since PET bottles have various side face shapes and outside diameter variation at an arbitrary height, a different level of shrinkage according to a height of the bottle is needed even for a label for covering one bottle. Therefore, needed is a heat-shrinkable polyester film having more excellent shrinkage characteristics than those in conventional articles, and exhibiting outstanding quality after shrink-finishing also in uses for covering of bottles with complicated side face shapes.

Furthermore, increasing is a case where wrapping and shrinking of labels of PET bottles for drinks are performed in a beverage charging line for productivity improvement. In such a charging line, since operations are performed at high speeds, high-speed wrapping and shrinking of labels tend to require shrinking to be performed in a short time. Accordingly, there are needed physical properties withstanding higher-speed wrapping, and shrinking performance giving a higher shrinkage percentage in a shorter time in heat-shrinkable polyester films.

In addition, in these days, the labels used for various containers such as PET bottles are also expected to have a function for reinforcing these containers. However, labels obtained from conventional heat-shrinkable polyester films did not have satisfactory reinforcing function.

In addition, since containers having labels covered and shrunk are often packed in a sate of high temperature (boxing etc.), especially in the case of full label, there occurs a problem of adhesion (blocking) of labels to each other between packed containers.

Furthermore, from a viewpoint of productivity improvement in a film-formation process or a post processing process, for heat-shrinkable films needed are a higher speed transferring of long films, and production of film rolls by winding at a higher speed, and as result also needed is excellent slip property to some extent for corresponding to the production process. In some cases, insufficient slip property of the film possibly generate defects of handling in transferring and winding at higher speeds. In detail, for example, in areas where film contacts guide roll at the time of film transferring, a tension of the film made to increase may form abrasion marks on a film surface, and in some cases may form a defect of crinkling or pimple shaped defect (minute projection formed with air caught between films) of a film wound in roll.

Furthermore, in these days, the label is also utilized for the purpose of avoiding change in quality and coloring of contents (beverages etc.) charged in the container with ultraviolet radiation entering from container outside. Conventionally, ultraviolet radiation cut type shrink films made of polyvinyl chloride were generally used, but demands on films constituted of materials other than polyvinyl chloride is increasing according to the above-described reasons. Ultraviolet radiation cut property demanded concretely may vary according to content. For example, in the case of contents of foodstuffs or beverages, since ultraviolet radiation with long wavelength of 360 to 400 nm may cause change in quality, coloring, etc. of the contents of foodstuffs or beverages, property allowing cut of ultraviolet radiation in such a wavelength band is desirable. However, there could not be found labels enabling cut of the ultraviolet radiation in such a longer wavelength region in conventional labels made of polyesters.

In production of labels etc., following methods are usually adopted. That is, raw material polyester is continuously extruded in a molten state. An undrawn film is manufactured. Subsequently, the undrawn film is drawn and wound to give a heat-shrinkable polyester film roll. The film in the roll is then unwound and slit into a film with a desired width, the slit film being rewound into another roll. Subsequently, various information and figures such as product name etc. are printed on the resulting film. After printing, the film is folded and bonded along both edges by means of, for example, solvent adhesion, to give a tubular film (in tubing process). Meanwhile, there may be cases where the printing and the slitting processes are performed in a reversed sequence. The tubular film thus obtained may be cut into tubular labels with a desired length, being further converted into bags by bonding along an edge of openings thereof.

Subsequently, containers wrapped in the labels or the bags above are passed, for example on a belt conveyer, through a shrinking tunnel (a steam tunnel) wherein heated steam is blown in for heat shrinking or a hot-air tunnel wherein hot air is blown in, to give final products (labeled containers) having the labels or the bags tightly attached thereon.

When each of labels, bags, etc. have a large variation of heat shrinkage percentage among them in this heat shrinking process, there may occasionally be produced defective labels and bags failing to give proper heat shrinkage percentage, since the tunnel is controlled in a same heating conditions during the production. As a result, large variation in the heat shrinkage properties leads to products inferior in appearance caused by insufficient shrinkage, shrinkage shading, crinkling, deformation in printed drawings, uneven shrinkage in a direction orthogonal to a maximum shrinkage direction, etc., and the product can not be shipped to market. Usually, labels or bags for a specific product are produced from a single film roll, and thus large variation in heat shrinkage properties of a film in a film roll leads to a higher defective fraction in the heat shrinkage process.

The present invention is completed in the light of the above-mentioned circumstances. A first object of the present invention is to provide a heat-shrinkable polyester film having excellent blocking resistance, outstanding film-formation property, and processability, on the premise of a film giving excellent quality after shrink-finishing, and having function allowing reinforcing a container wrapped by film. A second object of the present invention is, in addition to the above-described premise, to provide a heat-shrinkable polyester film having function enabling prevention of quality deterioration, caused by ultraviolet radiation, of the contents in the container while further securing visibility of contents. A third object of the present invention is to provide a heat-shrinkable polyester film roll enabling solution of various problems in the production processes described above by suppression of variation in heat shrinkage properties of the long film, decreasing occurrence of defects in the products, in processes of producing heat-shrinkable labels, bags etc. from a roll of a long film and of wrapping and shrinking the same onto the containers to produce labeled container products.

### DISCLOSURE OF THE INVENTION

A heat-shrinkable polyester film of the present invention achieving the first object satisfies following requirements (A) to (E), that is:

(A) a heat shrinkage percentage in a maximum shrinkage direction of a sample is 10% to 50%,

wherein, the sample is prepared and treated under following conditions:

a heat-shrinkable polyester film is cut into a shape of a square measuring 10 cm×10 cm;

the sample obtained is immersed in hot water at 70° C. for 5 seconds and then withdrawn from the hot water, and subsequently is immersed in water at 25° C. for 10 seconds, and then withdrawn from the water;

(B) a heat shrinkage percentage of a sample in a maximum shrinkage direction is not less than 75%, and a heat shrinkage percentage in a direction orthogonal to the maximum shrinkage direction is not more than 10%,

wherein, the sample is prepared and treated under following conditions:

a heat-shrinkable polyester film is cut into a shape of a square measuring 10 cm×10 cm;

the sample obtained is immersed in hot water at 85° C. for 5 seconds and then withdrawn from the hot water, and subsequently is immersed in water at 25° C. for 10 seconds, and then withdrawn from the water;

(C) a heat shrinkage percentage difference of a sample ΔX (%) represented by a following equation is 10% to 20%,
ΔX=X₀−X₁₀
wherein, X₀ and X₁₀ are defined as follows,
X₀: a heat shrinkage percentage in a maximum shrinkage direction of a sample obtained by cutting a heat-shrinkable polyester film into a shape of a square measuring 10 cm×10 cm;
X₁₀: a heat shrinkage percentage in a maximum shrinkage direction of a film obtained by cutting a heat-shrinkable polyester film having experienced heat shrink by 10% in a maximum shrinkage direction; and
wherein, the sample obtained is immersed in hot water at 95° C. for 5 seconds and then withdrawn from the hot water, and subsequently is immersed in water at 25° C. for 10 seconds, and then withdrawn from the water;

(D) a three-dimensional surface roughness SΔa is 0.008 to 0.04; and

(E) a three-dimensional surface roughness SRz is 0.6 μm to 1.5 μm.

A second aspect achieving the above-described second object is a heat-shrinkable polyester film satisfying following requirements, in addition to (A) to (C), that is:

(F) a light transmission at a wavelength of 380 nm is not more than 20%, and a light transmission at a wavelength of 400 nm is not more than 60%; and

(G) a Haze value is not more than 15%.

A third aspect achieving the above-described third object is a film roll of a heat-shrinkable polyester film having a length of 1000 to 6000 m, the heat-shrinkable polyester film satisfying following requirements (a) to (c):

(a) an average of heat shrinkage percentages in a maximum shrinkage direction of samples is 10% to 50%,

wherein, the samples are obtained in a following manner:

an initiation end of winding of a film of steady region giving stable film properties in a longitudinal direction is defined as a first end, and a termination end of winding thereof is defined as a second end;

a first cut-off point of the samples of the film is provided less than 2 m inside of the second end, and a final cut-off point is provided less than 2 m inside of the first end;

a plurality of the sample cut-off points are provided at an interval of about 100 m from the first cut-off point, and the samples are obtained by cutting into a shape of a square measuring 10 cm×10 cm at each sample cut-off point; and wherein the samples are treated in a following manner:

the samples obtained are immersed for 5 seconds in hot water at 70° C. and then withdrawn from the hot water, and subsequently immersed in water at 25° C. for 10 seconds, and then withdrawn from the water;

(b) an average of heat shrinkage percentages in a maximum shrinkage direction of samples is not less than 75%, and a heat shrinkage percentage in a direction orthogonal to the maximum shrinkage direction is not more than 10%,

wherein, the samples are treated in a following manner:

each sample in a shape of a square measuring 10 cm×10 cm is separately cut from each cut-off point of sample in the requirement (a);

the obtained samples are immersed for 5 seconds in hot water at 85° C., and then withdrawn from the hot water, and subsequently, immersed in water at 25° C. for 10 seconds, and then withdrawn from the water.

(c) a heat shrinkage percentage difference ΔX (%) of samples at all the cut-off points of samples represented by following equation is in a range of 10% to 20%,
ΔX=X₀−X₁₀
wherein, X₀ and X₁₀ are defined as follows,

X₀: a heat shrinkage percentage in a maximum shrinkage direction measured for each sample in a shape of a square measuring 10 cm×10 cm separately cut from each cut-off point of sample in the requirement (a) being immersed for 5 seconds in hot water at 95° C., then withdrawn from the hot water, and subsequently, being immersed in water at 25° C. for 10 seconds, and then withdrawn from the water;

X₁₀: a heat shrinkage percentage in a maximum shrinkage direction measured in a same manner for each sample obtained by cutting into a shape of a square measuring 10 cm×10 cm after shrunk by 10% in a maximum shrinkage direction of a cut sample in a shape of a square measuring 25 cm×25 cm separately cut from each cut-off point of sample in the requirement (a).

### BEST MODE FOR CARRYING OUT OF THE INVENTION

A heat-shrinkable polyester film of the present invention is obtained using single copolymerized polyester having an ester unit formed of publicly known polybasic carboxylic acid components and polyhydric alcohol components as a principal constitutional unit, and a mixture of 2 or more polyesters.

Requirements (A) and (B)

A heat shrinkage percentage of the heat-shrinkable polyester film of the present invention, measured under conditions of the above (A) and (B) is a value of (A): not less than 10% and not more 50%, and (B): not less than 75% in a maximum shrinkage direction, and not more than 10% in a direction orthogonal to the maximum shrinkage direction. Such a film may provide a heat-shrinkable label giving a high shrinkage percentage by a comparatively short-time treatment.

Generally, in wrapping and shrinking process of a label manufactured by a heat-shrinkable film onto a container etc., the above-described hot air tunnel uses conditions of about a temperature of 120 to 200° C., a wind velocity of 2 to 20 m/second, and a period of time of about 2 to 20 seconds, and a steam tunnel uses conditions of a temperature of 75 to 95° C., a pressure of about 0.5 to 20 MPa, and a period of time of about 2 to 20 seconds. A film satisfying the range for all the heat shrinkage percentages of (A) and (B), for example, may fulfill extremely beautiful shrinking finish visual appearance under usually performed shrinking conditions even in use as a heat-shrinkable label for covering a great portion of a side surface for containers, such as PET bottle, having a complicated side face shape, and in use as a heat-shrinkable label for containers having side face shape requiring partially a very high shrinkage percentage with respect to a label for covering the side surface (for example, uses for a full label usage for PET bottles, a full label usage for glass bottles, etc.)

That is, on one hand, when a heat shrinkage percentage measured under the condition of (A) is less than the above-mentioned range, an insufficient low-temperature shrinkable will be given, leading to disadvantageous necessity of giving a higher temperature at the time of label covering shrinking. On the other hand, when a heat shrinkage percentage measured under the condition of (A) exceeds the above-mentioned range, there may be a tendency of occurrence of some defects, such as jumping (an upward shift of the label caused by rapid shrink of the film) of a label when the label is made to shrink and wrap a PET bottle etc. The heat shrinkage percentage measured under a condition of (A) is preferably not less than 15% and not more than 40%.

In addition, when a heat shrinkage percentage in a maximum shrinkage direction measured under the condition of (B) is less than the range, for example, in a label wrapping and shrinking on a PET bottle etc., the label is apt to give insufficient shrinkage in portions (for example, inlet portion of the bottle etc.) needing a larger shrinkage percentage. The heat shrinkage percentage measured under the condition of (B) is preferably not less than 78% and not more than 95%.

Furthermore, visual defects caused by uneven shrinkage in a direction orthogonal to a maximum direction occurs, when a heat shrinkage percentage in the direction orthogonal to the maximum shrinkage direction (heat shrinkage percentage in the orthogonal direction) measured under the condition of (B) exceeds the above-mentioned range. Here, “uneven shrinkage” means that a length of the label after shrinkage is uneven, and leads to a defect in appearance. For example, an uneven label wrapped and shrunk around a PET bottle etc. has a top edge line of the label curved downward or a bottom edge line curved upward. A heat shrinkage percentage in the orthogonal direction measured under the condition of (B) is preferably not more than 7%.

Requirement (C)

In addition, a heat shrinkage percentage difference ΔX of the heat-shrinkable polyester film of the present invention represented with following equation (%) gives not less than 10% and not more than 20%.
ΔX=X₀(%)−X₁₀(%)

Heat shrinkage percentages are defined in such a manner that a heat shrinkage percentage in a maximum shrinkage direction measured under the above-described condition (C) for a film before heat shrinking is defined as X₀(%); a film before heat shrinking is once heat shrunk by 10% in a maximum shrinkage direction, and a heat shrinkage percentage of the obtained film in a maximum shrinkage direction measured under the above-described condition (C) is defined as X₁₀(%)

A heat-shrinkable polyester film giving the above-described heat shrinkage percentage difference ΔX within an above-mentioned range can provide a heat-shrinkable label having reinforcing effect for a wrapped container.

A heat-shrinkable label obtained from a heat-shrinkable polyester film giving the heat shrinkage percentage difference ΔX less than the above-mentioned range provides insufficient reinforcing effect for a container after wrapping and shrinking. A preferable heat shrinkage percentage difference ΔX of the heat-shrinkable polyester film of the present invention is not more than 17%. By the way, since the heat shrinkage percentage X₁₀ is a value measured using a film experiencing heat shrinking of 10%, a lower limit of the heat shrinkage percentage difference ΔX is not less than 10%.

Incidentally, when usual heat-shrinkable polyester films are again heat shrunk after once experiencing heat shrinking by 10%, a final heat shrinkage percentage of the film (a total amount of 10% of a first heat shrinkage percentage, and a second heat shrinkage percentage) drops more greatly than a heat shrinkage percentage in case of having shrunk the film before heat shrinking completely under a same heat shrinking condition (that is, the heat shrinkage percentage difference Δ will exceed the above-mentioned range). The film of the present invention uses a preferable composition of polyesters used for the film as described later, and at the same time needs control of drawing conditions of the film to secure a heat shrinkage percentage difference ΔX in the above-mentioned range.

The “heat shrinkage percentage in a maximum shrinkage direction” described above represents a heat shrinkage percentage in a direction giving a greatest shrinking of a sample, and the maximum shrinkage direction and the orthogonal direction are determined by a length in a lengthwise direction or horizontal direction of a square. A value of a heat shrinkage percentage (%) is determined according to a following equation.
Heat shrinkage percentage=100×(length before shrinking−length after shrinking)/(length before shrinking)

Preparation and treatment of a sample are performed by following methods. That is, samples measuring 10 cm×10 cm are immersed for 5 seconds, and are heat shrunk in a no-load state under following conditions, respectively, and treated in such a manner that condition (A): in hot water at 70° C.±0.5° C.; condition (B): in hot water at 85° C.±0.5° C.; and condition (C); in hot water at 95° C.±0.5° C. for a heat shrinkage percentage X₀, subsequently the samples are immediately immersed in water at 25° C.±0.5° C. for 10 seconds in a no-load state, and then, lengths in a lengthwise direction and horizontal direction of a square are measured.

The heat shrinkage percentage X₁₀ used for calculation of the heat shrinkage percentage difference ΔX is measured in a following manner. First, a film beforehand experienced 10% of heat shrink in a maximum shrinkage direction is manufactured. A gripping device having two mutually facing chucks is prepared for gripping only a pair of mutually facing edges of a rectangular film. A heat-shrinkable polyester film is cut into a square or a rectangle in parallel with respect to a maximum shrinkage direction. The film after cut is fixed with the gripping device. Both ends orthogonal to the maximum shrinkage direction of the film are gripped by the chucks, and the film is fixed in such a way that the film may have a slack to give a ratio of a film length between chucks to a distance between chucks of gripping device of 1:0.9. Subsequently, the film fixed to the device is immersed in hot water at 95° C. ±0.5° C. in a no-load state, for 5 seconds, and is heat shrink, and the film is immediately immersed in water at 25° C.±0.5° C. for 10 seconds in a no-load state, and then withdrawn out from the water. This film is removed from the chucks, and water is removed to obtain a film having experienced 10% of heat shrink in a maximum shrinkage direction.

A sample measuring 10 cm×10 cm is cut out from the obtained film, a heat shrinkage percentage X₁₀ is measured using this sample by a same method as that used for the heat shrinkage percentage X₀. A heat shrinkage percentage difference ΔX is calculated by a following equation.
ΔX=X₀−X₁₀

In addition, both of a period of time between a manufacturing process of the film having experienced 10% of heat shrink in a maximum shrinkage direction, and a sample cutting process, and a period of time between a sample cutting process and a heat shrink process under conditions of (C) are preferably as short as possible. When a film having experienced 10% of heat shrink in a maximum shrinkage direction is preserved until the sample cutting process, and when the cut sample is preserved until the heat shrink process, the sample is to be preserved in a state of unstrained and under environment of air and at a temperature not more than 25° C. to suppress unnecessary heat shrink.

Requirement (D)

In order to achieve the first object, a three-dimensional surface roughness SΔa of a heat-shrinkable polyester film gives a value of preferably not less than 0.008 and not more than 0.04. (Requirement (D)). Control of SΔa within the range enables securing excellent film-formation property and processability. The three-dimensional surface roughness SΔa may be measured with a three-dimensional roughness gauge (for example, product of Kosaka Seisakusho “ET-30K”). The three-dimensional surface roughness SΔa means a three-dimensional average inclination, and is measured in such a manner that at each of 150 points set in arbitrary directions of a film at intervals of 2 μm by a plane view, an average inclination Δa defined by a following equation is measured in a direction orthogonal the directions, obtaining an average of measured results in these all points. For example, the above-mentioned 150 points are set in TD direction (an orthogonal direction to a running direction in film production) of a film, and an average inclination Δa is measured in MD direction (a running direction in film production) of the film.

$$Δ a = \frac{1}{L} {\int }_{0}^{L} \vert \frac{ⅆ}{ⅆ x} f ( x ) \vert ⅆ x$$

[where, f(x) represents a profile curve, and in detail, it represents a size of unevenness at coordinate x set in a measurement direction (the value is positive in case of being higher than a mean line, and negative in case of lower than the mean line), and L represents a measurement length.]

On one hand, an excessively small SΔa will reduce transferring property in film production, provide a possibility of giving scratches to a film surface in transferring. On the other hand, an excessively large SΔa will deteriorate tear resistance of the film, and generate a white powder in film transferring, resulting in printing omission. A lower limit of the SΔa is more preferably 0.01, and still more preferably 0.012. In addition, an upper limit of the SΔa is more preferably 0.035, and still more preferably 0.03.

Requirement (E)

In addition, in order to achieve the first object, a three-dimensional surface roughness SRz of the heat-shrinkable polyester film of the present invention is preferably not less than 0.6 μm, and not more than 1.5 μm. Control of the SRz within the range can improve blocking resistance after container wrapping. The three-dimensional surface roughness SRz may be measured in a same manner as in the SΔa with a three-dimensional roughness gauge (for example, product of Kosaka Seisakusho “ET-30K”).

The three-dimensional surface roughness SRz means three-dimensional ten point height of irregularities, and when 150 points are set in arbitrary direction of a film at intervals of 2 μm by a plane view, the value is obtained in such a manner that a ten point height of irregularity Rz is measured in a direction orthogonal to the arbitrary direction at each of 150 points, obtaining an average of measured results in these all points. For example, the above-mentioned 150 points are set in TD direction (an orthogonal direction to a running direction in film production) of a film, and a ten point height of irregularities Rz is measured in MD direction (a running direction in film production) of the film.

On one hand, an excessively small SRz easily gives blocking, for example, when full labels are produced from a film and containers are wrapped by shrinking and the wrapped containers are packed (boxing etc.) in a hot state etc. On the other hand, an excessively large SRz will deteriorate tear resistance of the film, and generate a white powder in film transferring, resulting in printing omission. A lower limit of SRz is more preferably 0.65 μm, and still more preferably 0.7 μm. In addition, an upper limit of SRz is more preferably 1.3 μm, and still more preferably 1.0 μm.

Lubricants

Inclusion of lubricants in a film of the present invention will control SΔa and SRz in the above-mentioned range.

The lubricants include inorganic particles (inorganic lubricants), organic salt particles, polymer particles, etc. The inorganic particles include carbonates (carbonates of alkaline earth metal, such as calcium carbonate, magnesium carbonate, and barium carbonate etc.), sulfates (sulfates of alkaline earth metal, such as barium sulfate etc.), phosphates (phosphates of alkali metal, such as lithium phosphate, phosphates of alkaline earth metal, such as calcium phosphate and magnesium phosphate etc.), oxide particles (aluminum oxide, silicon oxide, titanium oxide, zirconium oxide, etc.), Kaolin, talc, lithium fluoride, etc. Silica (silicon oxides) particles are preferable among them. Especially preferable silica particle is aggregates formed of aggregation of primary particles. Such silica particles have excellent handling property, and are useful for obtaining a film with excellent transparency.

Organic salt particles include oxalates (oxalates of alkaline earth metal, such as calcium oxalate etc.), and terephthalates (alkaline earth metal salt, such as calcium salt, magnesium salt, and barium salt, zinc salt, manganese salt, etc.)

Polymer particles include homo polymers or copolymers of vinyl monomers, such as divinylbenzene, styrene, and (meth) acrylic acid, polytetrafluoroethylenes, benzoguanamine resins, thermosetting urea resins, thermosetting phenolic resins, etc. Especially crosslinked polymer particles are preferable.

A mean particle diameter of these lubricants is preferably not less than 0.01 μm, and not more than 4 μm, and more preferably not less than 0.05 μm, and not more than 3.5 μm. A mean particle diameter of the lubricants less than the above-mentioned range makes it difficult to give SΔa not less than the lower limit, and a mean particle diameter exceeding the above-mentioned range of the lubricants makes it difficult to give SRz not more than the upper limit. A mean particle diameter of the lubricants as used herein is a nominal value by lubricant manufacturers, and it is a mean particle diameter measured for particles after adjustment of particle diameter by means of pulverizing of aggregates of primary particles.

In addition, it is recommended that an amount of addition of the lubricants is controlled to give not less than 0.02 mass %, and not more than 0.5 mass % in a whole amount of a film, and more preferably not less than 0.03 mass % and not more than 0.4 mass %. In case of the film having a plurality of layers, as described later, a content of lubricants to whole amount of the layer, for each layer, is adjusted for two-layers located on a top surface to give a value of not less than 0.02 mass % and not more than 0.5 mass %, and preferably not less than 0.03 mass % and not more than 0.4 mass %. An amount of addition of lubricants less than the above-mentioned range makes it difficult to give the SΔa not less than the lower limit, and an amount of addition exceeding the above-mentioned range of lubricants makes it difficult to give SΔa not more than the an upper limit.

A timing of addition of the lubricants is not especially limited, and addition in polymerization and addition to polyesters in an extruder is preferable.

Requirement (F) (Ultraviolet Radiation Cutting Property)

In order to fulfill the second object, in addition to satisfying the requirements (A) to (C) by the heat-shrinkable polyester film, a light transmittance of the film at a wavelength of 380 nm is preferably not more than 20% (0% is included), and a light transmittance at a wavelength of 400 nm is preferably not more than 60% (0% is included). As described above, change in quality, coloring, etc. of contents (foodstuffs, beverages, etc.) in a container can mainly be caused by ultraviolet radiation in 360 nm to 400 nm wavelength band. Then, setting of light transmittance of the film of the present invention at wavelengths of 380 nm and 400 nm not more than the upper limit value may provide a heat-shrinkable label having excellent ultraviolet radiation cutting property and realizing suppression of quality deterioration of contents in the container.

That is, a film having a light transmittance at a wavelength of 380 nm and/or a light transmittance at a wavelength of 400 nm exceeding the upper limit value cannot provide a heat-shrinkable label allowing enough suppression of quality deterioration of contents in the container caused by ultraviolet radiation. The light transmittance at a wavelength of 380 nm is more preferably not more than 10%, and further preferably not more than 5%. And the light transmittance at a wavelength of 400 nm is more preferably not more than 50%, and further preferably not more than 30%. An excessively small light transmittance at a wavelength of 400 nm may make the film colored. Accordingly, in order to prevent such coloring of the film, the light transmittance at a wavelength of 400 nm is preferably set not less than 5%, more preferably not less than 10%, and still more preferably not less than 20%. Each of the light transmittance is determined by measuring methods later described in Example.

Requirement (G) (Natural Light Transmittance)

In order to achieve the second object, a haze of a heat-shrinkable polyester film is preferably not more than 15%, more preferably not more than 10%, and still more preferably not more than 5%. Since the film of the present invention has excellent ultraviolet radiation cutting property as described above, and in addition a haze not more than the upper limit value, it has outstanding transmissivity to natural light (visible light) etc., and represents excellent visibility of contents in the container in use to labels for container wrapping. The haze is determined by measuring methods described later in Example.

Ultraviolet Radiation Cutting Agent

Inclusion in a film of ultraviolet radiation cutting agents (low molecular weight ultraviolet radiation cutting agents, high molecular weight ultraviolet radiation cutting agents, inorganic ultraviolet radiation cutting agents, etc.), and further suitable selection of kinds, types of inclusion, etc. of the ultraviolet radiation cutting agents may allow coexistence of both of the ultraviolet radiation cutting property and natural light transmittance. The ultraviolet radiation cutting agents may be included in the film by extrusion molding (film-formation process) after kneading the agents into the molten polyester (kneading method). In addition, the agents may be included into the film by, for example, an applying method or impregnation method, and the kneading method is more preferable. The kneading method may increase a thickness of ultraviolet radiation cut layers, and may improve the ultraviolet radiation cutting property of the film.

A content of ultraviolet radiation cutting agents in the polyester film may be appropriately selected according to kinds of ultraviolet radiation cutting agents, and for example, it is approximately 0.1 to 50 mass %, preferably approximately 0.3 to 40 mass %, and more preferably approximately 0.5 to 30 mass %. In use of lower molecular weight ultraviolet radiation cutting agents, an upper limit of the amount to be used may be smaller, for example, the upper limit may be approximately 10 mass %, and preferably approximately 5 mass %. Hereinafter, according to kinds of the ultraviolet radiation cutting agents, detailed descriptions will be given.

(1) Use of Lower Molecular Weight Ultraviolet Radiation Cutting Agents

Lower molecular weight ultraviolet radiation cutting agents are organic ultraviolet radiation cutting agents enabling absorption of ultraviolet radiation, and since they have similar refractive indexes to visible light as refractive indexes to visible light of the polyester film, they do not have a possibility of reducing the transmissivity of natural light. However, since the lower molecular weight ultraviolet radiation cutting agents have lower heat-resisting property, and/or they have sublimability at higher temperatures, they may be in some cases unable to give sufficient ultraviolet radiation cutting property. For example, the lower molecular weight ultraviolet radiation cutting agent is often made to included in a film by methods of kneading into a molten polyester, and of film-formation by extrusion molding etc. (film-formation process). However, decomposition and sublimation of the lower molecule ultraviolet radiation cutting agent may be induced during kneading and extrusion molding steps, sometimes leading to drop of the ultraviolet radiation cutting property of the film, and to pollution of manufacturing facilities (casting rolls used in film-formation).

Therefore in the present invention, in use of lower molecular weight ultraviolet radiation cutting agents, a laminated film with a plurality of layers (for example, three or more layers, that is, three layers, four layers, five layers, etc.) is preferably formed, by a co-extruding method etc., and the lower molecular weight ultraviolet radiation cutting agent is preferably made to be included in part or all layers (preferably in all layers) that do not form surface layers (hereinafter, referred to as an internal layer). Inclusion in the internal layer of the lower molecular weight ultraviolet radiation cutting agent may at least prevent sublimation of the ultraviolet radiation cutting agent, and can improve yield of the ultraviolet radiation cutting agent in the film-formation process, resulting in improvement in the ultraviolet radiation cutting property of the film, and in realization of prevention of pollution to the manufacturing facilities. In addition, the ultraviolet radiation cutting agent may or may not be made to be included in the surface layers.

As the lower molecular weight ultraviolet radiation cutting agent, for example, include compounds represented with following formula (1), such as, “Bonasorb 3901,” a ultraviolet radiation cutting agent, manufactured by Orient chemical Industries, Ltd. etc.; compounds represented with following formula (2), a benzotriazol ultraviolet radiation cutting agent “Tinuvin® 326” manufactured by [Ciba Specialty Chemicals etc.; compounds represented with following formula (3), such as “LA-31” manufactured by Asahi Denka Co., Ltd. etc.; benzophenone ultraviolet radiation cutting agents; cyanoacrylate ultraviolet radiation cutting agents; and phenyl salicylate ultraviolet radiation cutting agents etc. 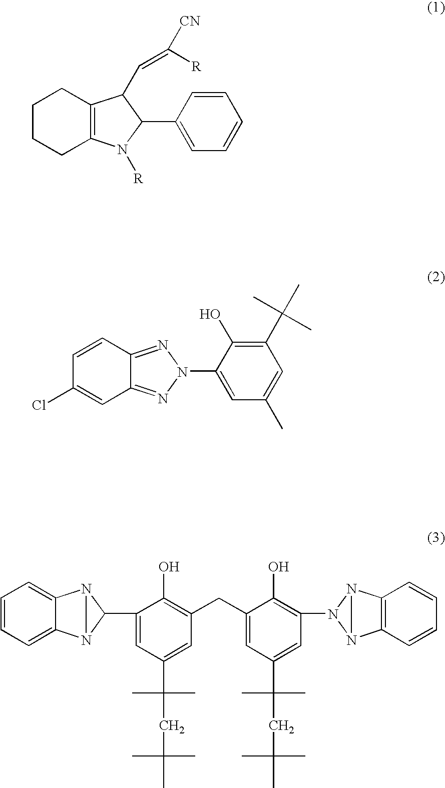
(where, R represents alkyl group.)
(2) Use of Ultraviolet Radiation Cutting Polymers

Like the lower molecular weight ultraviolet radiation cutting agents, higher molecular weight ultraviolet radiation cutting agents (ultraviolet radiation cutting polymers) are also organic ultraviolet radiation cutting agents that can absorb ultraviolet radiation, and since they have similar refractive indexes to visible light as that of the polyester film, there is no possibility of reducing natural light transmittance. In addition, unlike the lower molecular weight ultraviolet radiation cutting agents, the ultraviolet radiation cutting polymers have outstanding heat-resisting property, therefore leading to prevention of thermal decomposition in the film-formation process, and to improvement in yield of the ultraviolet radiation cutting polymers. Therefore, the ultraviolet radiation cutting polymers may be made to be included in a single layered polyester film in use of the ultraviolet radiation cutting polymers.

Also in case of use of the ultraviolet radiation cutting polymers, the ultraviolet radiation cutting polymers may be made to be included in all or in partial (preferably in all) internal layers as in use of the lower molecular weight ultraviolet radiation cutting agents. Inclusion of the ultraviolet radiation cutting polymers in the internal layers may improve yield of the ultraviolet radiation cutting polymers, and even when the ultraviolet radiation cutting polymers have having sublimability, ultraviolet radiation cutting property of the film may subsequently be improved, leading to prevention of pollution of manufacturing facilities.

As the ultraviolet radiation cutting polymers, commonly used various ultraviolet radiation cutting polymers may be used. Preferable ultraviolet radiation cutting polymers include polymers obtained from monomers having ultraviolet absorption property (naphthal imide compounds etc.) For example, there may be used copolyesters including naphthalene dicarboxylic acids and naphthal imido compound represented with following formula (4) “Novapex® U110”, manufactured by Mitsubishi Chemical, Inc. etc. as acid components. 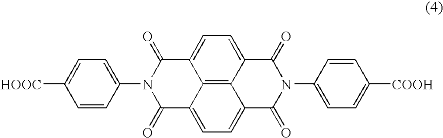
(3) Use of Inorganic Ultraviolet Radiation Cutting Agents

Inorganic ultraviolet radiation cutting agents can cut ultraviolet radiation by cutting off the ultraviolet radiation. These cutting agents have excellent heat-resisting property, and may give improved yield in a film-formation process, resulting in easier improvement of ultraviolet radiation cutting property of films. However, since the inorganic ultraviolet radiation cutting agents have refractive indexes different from refractive indexes of polyester films to visible light, unlike the organic ultraviolet radiation cutting agents (lower molecular ultraviolet radiation cutting agents, ultraviolet radiation cutting polymers, etc.), they may have a possibility of reducing natural light transmittance. Then, in use of the inorganic ultraviolet radiation cutting agents, used are micro-particle-shaped cutting agents having a mean particle diameter smaller than wavelengths of visible light. Use of the inorganic micro-particle-shaped ultraviolet radiation cutting agents can cut off ultraviolet radiation, without reducing the natural light transmittance. A mean particle diameter of the inorganic ultraviolet radiation cutting agents is, for example, not more than 100 nm, preferably not more than 70 nm, and more preferably not more than 40 nm. A mean particle diameter of the inorganic ultraviolet radiation cutting agents is usually not less than 10 nm.

Also in use of the inorganic ultraviolet radiation cutting agents, the ultraviolet radiation cutting agents may be included in all or in partial internal layer (preferably in all layers) as in use of the lower molecule ultraviolet radiation cutting agents. Even in the case where the inorganic ultraviolet radiation cutting agents have sublimability, inclusion in internal layers of the ultraviolet radiation cutting agent can improve yield of the ultraviolet radiation cutting agents, and can improve the ultraviolet radiation cutting property of the film.

As the inorganic ultraviolet radiation cutting agents, titanium ultraviolet radiation cutting agents (titanium dioxide etc.) etc. may be mentioned.

Maximum Value of Heat Shrinkage Stress

A heat shrinkage stress in the maximum shrinkage direction of the heat-shrinkable polyester film of the present invention after having experienced heat shrink by 10% in the maximum shrinkage direction preferably gives not less than 7 MPa. The value is measured under following conditions: hot-air (90° C., at a rate of 5 m/s); specimen width 20 mm; and distance between corresponding chucks 100 mm. Films having the maximum value of heat shrinkage stress of not less than 7 MPa can give heat-shrinkable labels having more excellent reinforcing effect of wrapped containers. That is, heat-shrinkable labels obtained from the film having the maximum value of heat shrinkage stress less than the above-mentioned range show a tendency of giving poor reinforcing effect of the wrapped containers. The maximum value of heat shrinkage stress is preferably not less than 10 MPa, and more preferably not less than 11 MPa.

The maximum value of heat shrinkage stress is measured by following methods.

[1] From a heat-shrinkable polyester film, a specimen having 200 mm in length in a maximum shrinkage direction, and 20 mm in width is cut out.

[2] Inside of a hot-air oven of a tensile testing machine (for example, “Tensilon” manufactured by Toyoseiki) provided with a hot-air oven is heated up to 90° C.

[3] Supply of hot-air therein is terminated and the specimen is set in the oven. A distance between corresponding chucks is set as 100 mm (constant). The specimen is loosened to give a ratio between a length of the specimen between chucks and a distance between chucks of (length of the specimen between chucks): (distance between chucks)=1:0.9.

[4] The door of the oven is immediately closed and supply of hot-air (90° C., at a rate of 5 m/s) is resumed. The specimen is heat shrunk by 10%, and a heat shrinkage stress after shrinking is detected and measured.

[5] A maximum value obtained from a resulting chart of the heat shrinkage stress is regarded as a maximum value of the heat shrinkage stress (MPa).

Thickness Distribution

The heat-shrinkable polyester film of the present invention preferably has a uniform thickness. When a thickness distribution (variation of thickness) in a maximum shrinkage direction of the film is measured for specimens with 50 cm in length, and 5 cm in width, the heat-shrinkable polyester film of the present invention preferably has not more than 6% of thickness distribution represented with following equation.
Thickness distribution=[(maximum thickness−minimum thickness)/(average thickness)]×100

The thickness distribution may be obtained in such a method that: 10 specimens, measuring 50 cm in length and 5 cm in width, having a length in a maximum shrinkage direction are prepared; a thickness in a longitudinal direction is continuously measured for each specimen using a contact type thickness gage (for example, “KG60/A” by ANRITSU CORP.) to output to a chart; a maximum thickness, a minimum thickness, and an average thickness are determined from the output; a thickness distribution is calculated using the above-described equation; and an average of the thickness distributions of ten specimens is determined.

Films having the thickness distribution exceeding 6% reduce printing property especially in printing multicolor patterns, and easily give color displacement in superposition of a plurality of colors in printing processes. In addition, the film makes superposition of adhesion portion of the film difficult in processing of tubing by solvent adhesion for producing labels from the film of the present invention. Furthermore, when rolling into a shape of a roll in a film manufacturing process, the film having the thickness distribution exceeding 6% induces partial difference of rolling hardness, and further gives slack and crinkling of film induced by the partial difference, possibly disabling use of the film as a heat-shrinkable film. The thickness distribution is more preferably not more than 5%, and especially preferably not more than 4%.

Melting Specific Resistance

The heat-shrinkable polyester film of the present invention preferably has a melting specific resistance at 275° C. of not less than 0.70×10⁸ Ω·cm. In cooling, by a casting roll, of a film melt extruded from an extruder, a smaller melting specific resistance can improve the electrostatic attraction of the film to the roll, and thereby stability of cooling solidification may be improved, leading to improvement of casting velocity (production speed) The melting specific resistance is more preferably not more than 0.65×10⁸ Ω·cm, and still more preferably not more than 0.60×10⁸ Ω·cm.

In addition, a lower melting specific resistance and higher electrostatic attraction can also improve film quality. In detail, lower electrostatic attraction gives unsatisfactory cooling solidification of the film, the film possibly locally entraps air between casting rolls and the film to form pinner bubbles (stripe-shaped defect) on a film surface. However, excellent electrostatic attraction can reduce occurrence of the pinner bubbles, and can give satisfactorily film visual appearance.

In addition, the melting specific resistance low enough and the electrostatic attraction high enough can give a uniform thickness of the film. In detail, lower electrostatic attraction to casting rolls provide uneven thickness of a cast undrawn film, and a drawn film obtained by drawing of the undrawn film has larger un-uniformity of thickness. However, electrostatic attraction high enough can give a uniform thickness to the drawn film also.

In order to control the melting specific resistance of the film in the above-mentioned range, desirable is inclusion of alkaline earth metal compounds and phosphorus including compounds in the film. Although only the alkaline earth metal compounds can reduce the melting specific resistance, coexistence of phosphorus including compounds can remarkably reduce the melting specific resistance. Reasons for combination of alkaline earth metal compounds and phosphorus including compounds being able to remarkably reduce the melting specific resistance is not clear, but it is probably because that inclusion of the phosphorus including compounds can decrease an amount of foreign matters, and can increase an amount of electric charge carriers.

A content of the alkaline earth metal compounds in the film is preferably not less than 40 ppm (based on mass, and so on), for example on the basis of alkaline earth metal atom M², more preferably not less than 50 ppm, and still more preferably not less than 60 ppm. Excessively smaller amount of alkaline earth metal compounds represents tendency of making drop of the melting specific resistance difficult. In addition, excessively large amount of content of the alkaline earth metal compounds saturates reduction effect by the melting specific resistance, and rather represents tendency for increasing harmful effects, such as foreign matter formation and coloring. Therefore, the content of the alkaline earth metal compounds is preferably not more than 400 ppm on the basis of the alkaline earth metal atom M², more preferably not more than 350 ppm, and still more preferably not more than 300 ppm.

A content of the phosphorus including compounds in the film is, for example, preferably not less than 10 ppm (based on mass, and so on) on the basis of phosphorus atom P, more preferably not less than 15 ppm, and still more preferably not less than 20 ppm. An excessively small amount of phosphorus including compounds may make it difficult to fully reduce melting specific resistance, and may not reduce formed amount of foreign matters. In addition, excessively great amount of content of the phosphorus including compounds will also saturate reduction effect of the melting specific resistance. Furthermore, since formation of diethylene glycol is accelerated and moreover control of the formed amount is difficult, desired film properties may possibly not be obtained. Therefore, a content of the phosphorus including compounds is, for example, preferably not more than 500 ppm on the basis of phosphorus atom P, more preferably not more than 450 ppm, and still more preferably not more than 400 ppm.

When reducing the melting specific resistance of the film using the alkaline earth metal compounds and the phosphorus including compounds, a mass ratio (M²/P) of the alkaline earth metal atom M² and the phosphorus atom P in the film is preferably not less than 1.5 (more preferably not less than 1.6, and still more preferably not less than 1.7). The melting specific resistance may remarkably be reduced by the mass ratio (M²/P) of not less than 1.5. In addition, the mass ratio (M²/P) exceeding 5.0 may increase formed amount of foreign matters, or may cause coloring of the film. Therefore, the mass ratio (M²/P) is preferably not more than 5.0, more preferably not more than 4.5, and still more preferably not more than 4.0.

The alkaline earth metal compounds include: hydroxides, alkoxides, salts with aliphatic carboxylic acids (such as acetate and butyrate, preferably acetates), salts with aromatic carboxylic acids (benzoate), salts with compounds having phenolic hydroxyl group etc. (salts with phenol etc.) of alkaline earth metals. Alkaline earth metals include: magnesium, calcium, strontium, barium (preferably magnesium), etc. Preferable alkaline earth metal compounds include: magnesium hydroxide, magnesium methoxide, magnesium acetate, calcium acetate, strontium acetate, barium acetate, etc., and especially magnesium acetate. The alkaline earth metal compounds may independently be used, or two or more kinds may be used in combination.

The phosphorus including compounds include: phosphoric acids (phosphoric acid, phosphorous acid, hypophosphorous acid, etc.) and esters thereof (alkyl esters, aryl esters, etc.); and alkyl phosphonic acids, aryl phosphonic acids, and esters thereof (alkyl esters, aryl esters, etc.). Preferable phosphorus compounds include: phosphoric acid, aliphatic esters of phosphoric acid (such as alkyl esters of phosphoric acid; for example, phosphoric acid mono C₁ to C₆ alkyl esters, such as phosphoric acid monomethyl ester, phosphoric acid monoethyl ester, phosphoric acid monobutyl ester; phosphoric acid di C₁ to C₆ alkyl esters, such as phosphoric acid dimethyl ester, phosphoric acid diethyl ester, phosphoric acid dibutyl ester etc.; phosphoric acid tri C₁ to C₆ alkyl esters etc., such as phosphoric acid trimethyl ester, phosphoric acid triethyl ester, phosphoric acid tributyl ester, phosphoric acid tributyl ester); aromatic esters of phosphoric acid (phosphoric acid mono-, di- or tri C₆ to C₉ aryl esters of phosphoric acid etc., such as triphenyl phosphate, tricresyl phosphate); aliphatic esters of phosphorous acid (alkyl esters of phosphorous acid, for example, mono-, di- or tri C₁ to C₆ alkyl esters of phosphorous acid, such as trimethyl phosphite, tributyl phosphite etc.); alkyl phosphononates (C₁ to C₆ alkyl phosphonates, such as methylphosphonate, ethylphosphonate); alkyl phosphonic acid alkyl ester (mono- or di C₁ to C₆ alkyl ester of C₁ to C₆ alkyl phosphonic acids, such as dimethyl methylphosphonate, dimethyl ethylphosphonate); aryl phosphonic acid alkyl ester (mono- or di C₁ to C₆ alkyl ester of C₆ to C₉ aryl phosphonic acids, such as dimethyl phenylphosphonate, diethyl phenylphosphonate); aryl phosphonic acid aryl esters (mono- or di C₆ to C₉ aryl esters of C₆ to C₉ aryl phosphonic acids, such as diphenyl phenylphosphonate) etc. Especially preferable phosphorus including compounds include phosphoric acid and trialkyl phosphate (trimethyl phosphate etc.). These phosphorus including compounds may independently be used, or two or more kinds may be used in combination.

In order to further reduce the melting specific resistance of the film, inclusion of alkali metal compounds in the film is desirable, in addition to the alkaline earth metal compounds and the phosphorus including compounds. Although independent inclusion in the film of the alkali metal compounds cannot reduce the melting specific resistance, addition of the alkali metal compounds into a coexistence system of the alkaline earth metal compounds and the phosphorus including compounds can remarkably reduce the melting specific resistance. Although the reason is not yet clear, it is estimated that formation of a complex with three members of the alkali metal compounds, the alkaline earth metal compounds, and the phosphorus including compounds may reduce the melting specific resistance.

A content of the alkali metal compound in the film is, for example, preferably not less than 0 ppm (based on mass, and so on), more preferably not less than 5 ppm, still more preferably not less than 6 ppm, and especially preferably not less than 7 ppm, based on alkali metal atom M¹. In addition, an excessive content of the alkali metal compounds saturates reduction effect or the melting specific resistance, and also increases an amount of a formed amount of a foreign matter. Therefore, the content of the alkali metal compounds is, for example, preferably not more than 100 ppm, more preferably not more than 90 ppm, and still more preferably not more than 80 ppm, based on the alkali metal atom M¹.

The alkali metal compounds include hydroxides, carbonates, aliphatic carboxylic acid salts (acetates and butyrates, preferably acetates), aromatic carboxylic acid salts (benzoates), and salts with compounds having phenolic hydroxyl group (salts with phenol etc.) of alkali metals etc. Alkali metals include lithium, sodium, potassium, etc. (preferably sodium). Preferable alkaline earth metal compounds include lithium hydroxide, sodium hydroxide, potassium hydroxide, lithium carbonate, sodium carbonate, potassium carbonate, lithium acetate, sodium acetate, potassium acetate, etc., especially sodium acetate.

Addition timing of the alkaline earth metal compounds and the phosphorus including compounds (and if necessary the alkali metal compounds) is not especially limited. Addition may be carried out in any stage, for example, before esterification reaction at the time of polyester polymerization, during esterification, between termination of esterification and polymerization process beginning, during polymerization, and after polymerization. The timing is preferably at any stage after esterification process, and it is more preferably between termination of esterification and polymerization process beginning. Addition of the alkaline earth metal compounds and the phosphorus including compounds (and if necessary the alkali metal compounds) after esterification process may reduce more foreign matter as compared to addition before esterification.

Composition of Polyester

A heat-shrinkable polyester film of the present invention has an ester unit formed from a polybasic carboxylic acid component and a polyhydric alcohol component as a principal constitutional unit. Polybasic carboxylic acids for forming polybasic carboxylic acid components in the ester unit include aromatic dicarboxylic acids such as terephthalic acid, isophthalic acid, naphthalene dicarboxylic acid, ortho-phthalic acid etc.; aliphatic dicarboxylic acids, such as adipic acid, azelaic acid, sebacic acid, decanedicarboxylic acid etc.; alicyclic dicarboxylic acids etc.; and ester formation derivatives etc.

In use of the above-described aliphatic dicarboxylic acids, the aliphatic dicarboxylic acid component is preferably less than 3 mole % in a polybasic carboxylic acid component 100 mole % of the film. Although described later for details, the heat-shrinkable polyester film of the present invention preferably has an ethylene terephthalate unit as a principal constitutional unit, in order to demonstrate tear resistance, strength, heat-resisting property, etc. Accordingly, terephthalic acid of the polybasic carboxylic acid component in the film is preferably a principal component. However, a heat-shrinkable label obtained from films having an amount of the aliphatic dicarboxylic acid components of not less than 3 mole % may undesirably not provide rigidity (stiffness of the film) for withstanding to high-speed wrapping on containers.

In addition, preferably polybasic carboxylic acids (for example, trimellitic acid, pyromellitic acid, anhydrides thereof, etc.) with not less than tribasic are not used. Sufficient heat shrinkage percentage may not be obtained with heat-shrinkable polyester films having these polybasic carboxylic acid components.

Ethylene glycol is used as an polyhydric alcohol for forming polyhydric alcohol component in ester unit in order to form ethylene terephthalate unit. In addition to the previously described materials, aliphatic diols, such as propylene glycol, 1,4-butanediol, 1,6-hexandiol, 3-methyl-1,5-pentanediol, neopentyl glycol, 2-methyl-1,5-pentanediol, 2,2-diethyl-1,3-propanediol etc. alicyclicdiols, such as 1,4-cyclohexane dimethanol, dimerdiols, bisphenol compounds or alkylene oxide addition products of derivatives thereof may also be used in combination.

For films of the present invention, preferably used are polyesters adjusted to have a glass transition temperature (Tg) of 60° C. to 75° C., using one or more kinds of diols of carbon number of 3 to 6 (for example, propylene glycol, 1,4-butanediol, neopentyl glycol, 1,6-hexandiol, etc.) and 1,4-cyclohexane dimethanol.

Especially, for securement of each of the heat shrinkage percentages, improvement in shrinking finished visual appearance, and securement of container reinforcing effect, polyesters obtained by use in combination of neopentyl glycol are preferably used. In a polyhydric alcohol components 100 mole % of the film, an amount of neopentyl glycol component is preferably 15 or more mole %, preferably not less than 18 mole %, and not more than 27 mole %, preferably not more than 25 mole %. In addition, when diols of carbon number of 3 to 6 other than neopentyl glycol are used, in polyhydric alcohol components 100 mole % of the film, these diol components are not less than 3 mole % and preferably not less than 5 mole %, and not more than 15 mole % and preferably not more than 13 mole %. In addition, in the case where 1,4-cyclohexane dimethanol is used, an amount of 1,4-cyclohexane dimethanol component in polyhydric alcohol components 100 mole % of the film are not less than 15 mole % and preferably not less than 18 mole %, and not more than 27 mole % and preferably not more than 25 mole %.

Diols (for example, octanediol etc.) with not less than 8 of carbon numbers excluding preferable polyhydric alcohols described above, and polyhydric alcohols not less than trihydric are not preferably used. Sufficient heat shrinkage percentage may in some case be difficult to be realized by heat-shrinkable polyester films having these diol components or polyhydric alcohol components.

In addition, although it is not polyhydric alcohols, lactones represented by ε-caprolactone may partially be used. Lactone rings open to form units having ester bonds at both ends.

In consideration of tear resistance, strength, and heat-resisting property of the film, ethylene terephthalate unit is preferably not less than 50 mole % in constitutional units 100 mole % of the heat-shrinkable polyester film. Therefore, the terephthalic acid component (component comprising terephthalic acid or esters thereof) is preferably not less than 50 mole % in the polybasic carboxylic acid components 100 mole %, and the ethylene glycol component is preferably not less than 50 mole % in the polyhydric alcohol components 100 mole %. The ethylene terephthalate unit is more preferably not less than 55 mole %, and still more preferably not less than 60 mole %.

Manufacturing Method of Polyester

Polyesters constituting the heat-shrinkable polyester film may be produced by conventional melt polymerization methods, and the methods include what is called a direct polymerization method, such as polycondensation of oligomers obtained by direct reaction of polybasic carboxylic acids and polyhydric alcohols; and what is called an ester interchange method, such as polycondensation after ester interchange reaction of methyl esters of polybasic carboxylic acids and polyhydric alcohols etc. In addition, polyesters obtained by other polymerization methods may also be used. A degree of polymerization of the polyesters preferably gives an intrinsic viscosity of 0.3 dl/g to 1.3 dl/g.

Conventional various catalysts may be used as polymerization catalysts, and, for example, usable catalysts include: titanium catalysts, antimony catalysts, germanium catalysts, tin catalysts, cobalt catalysts, manganese catalysts, etc., preferably titanium catalysts (titanium tetrabutoxide etc.), antimony catalysts (antimony trioxide etc.), germanium catalysts (germanium dioxide etc.), cobalt catalysts (cobalt acetate etc.) etc.

In addition, antioxidants, UV stabilizers, antistatic agents, colorants, antibacterial agents, etc. may be added in raw material of the film, if necessary.

Polyester films may be obtained by publicly known methods described later. Methods to make a plurality of components contained in the heat-shrinkable polyester film include a method of independent use of copolyester by means of copolymerization, and blending of different kinds of homopolyesters and/or copolyesters.

In a method of independent use of copolyester, there may be used copolymerized polyesters obtained from polyhydric alcohols with predetermined compositions, and polybasic carboxylic acids with predetermined compositions. On the other hand, a method of blending of polyester with different compositions may preferably be used, because properties of films can be easily changed only by changing blend ratios, and it may also industrially produce films of various kinds, this method is preferably employable.

In the blending method, in detail, it is preferable to blend and use two or more kinds of polyesters having different Tg. Three or more kinds of polyesters may also be blended.

In use of blend of two or more kinds of polyesters, for example, there may possibly occur such troubles that polyesters fail to exhibit compatibility to lead to whitening of resulting films. However, experience reveals that in a film extrusion process described later, usually heating causes an ester interchange reaction to convert polyesters included in the film into copolymerized polyesters, resulting in avoidance of troubles, such as whitening. Copolymer formation by such an ester interchange reaction can be identified in such a way that, for example, single Tg is usually given by publicly known method films obtained from two or more kinds of polyester blends having different Tg.

Manufacturing Method of Heat-Shrinkable Polyester Film

In detailed manufacturing method of a film, raw material polyester chips are dried using a dryer, such as hopper dryer and paddle dryer, or vacuum dryer, and are extruded into a shape of a film at temperatures of 200° C. to 300° C. using an extruder. Alternatively, undried polyester raw material chips are extruded into a shape of a film, while removing moisture within a vent type extruder. In extrusion, conventional methods, such as a T-die method, a tubular method, etc. are employable. After extrusion, the film obtained is immediately cooled to obtain an undrawn film. Undrawn film, as used herein, also include films having experienced application of a tension needed for film delivery in manufacturing process.

A film of the present invention may be of single layer, and may be of a laminated film obtained by laminating 2 or more of layers (for example, two-layered, three-layered, four-layered film, etc.) In the case of a laminated film, each layer may be made of a polyester having a same composition, and polyesters with different compositions are preferably used for every layer. In addition, in case of three-layered film, may be suitably used a configuration of using a polyester with identical composition for both outer layers, and a polyester with different composition in a central layer. A laminating method in case of adoption of such a laminated film is not especially limited, and for example, methods of obtaining the undrawn film by publicly known co-extruding methods etc. are employable.

In addition, as mentioned above, for equalization of a thickness distribution of the film, recommended is application of voltage between an electrode and casting rolls by disposing electrodes between the extruder and the casting rolls to electrostatically attract the film onto the rolls.

Then, drawing processing is given to the undrawn film. After cooling by the casting rolls etc., drawing processing may succeedingly be performed, and the undrawn film is once wound up in a shape of a roll after cooling, and then drawing processing may be performed. Since it is practical on manufacturing efficiency that a maximum shrinkage direction is a transverse (width) direction of the film, hereinafter, represented will be example of a method of drawing in case of a maximum shrinkage direction being a transverse direction. But it is also possible to draw the undrawn film to give a film having the maximum shrinkage direction identical with the longitudinal (lengthwise) direction of the film, according to common methods, for example, by changing the drawing direction for an angle of 90°.

In respect to equalization of the thickness distribution of the heat-shrinkable polyester film, and to realization of the value not more than the upper limit value, the film is preferably heated in a preheating process prior to the film being drawn in the transverse direction, for example, in a tenter in the drawing process. In this preheating process, a lower hot-air velocity is used so that a thermal conductance gives a value of not more than 0.00544 J/cm²·sec·° C. (0.0013 calory/cm²·sec·° C.), heating is preferably performed until the film surface temperature gives a certain temperature within a limit of Tg+0° C. to Tg+60° C.

Drawing in the transverse direction is performed at predetermined temperatures within a limit of Tg−5° C. to Tg+15° C. In the film of the present invention, the drawing will be performed in two or more stages in order that the heat shrinkage percentage of (A) and (B), and the heat shrinkage percentage difference Δ may give values in the above-mentioned ranges, and furthermore in order that the maximum value of heat shrinkage stress may give the value in the above-mentioned range. Description will, hereinafter, be given for a case of drawing in two stages.

First, a first stage of drawing is performed. A drawing ratio is not less than 4.4 times and not more than 6.0 times with respect to an undrawn film, and preferably not less than 4.8 times and not more than 5.5. Drawing temperatures in the first stage is determined as described above (predetermined temperatures within the range of Tg−5° C. to Tg+15° C.).

Next, heat setting is preferably performed for the film in a state with a tension in drawing direction. Tensioning ratio in the case is not less than 1% and not more than 6% with respect to the film after the first stage of drawing, and preferably not less than 2% and not more than 5%. In addition, the heat setting temperature is preferably a same temperature as in the first stage of drawing, or the heat setting temperature is set about 1 to 5° C. lower than the first stage drawing temperature within the temperature range. The heat setting period is not less than 0.5 seconds and not more than 5 seconds, and preferably not less than 1 second and not more than 3 seconds.

Then, the second stage of drawing is performed. The drawing ratio is not less than 1.1 times and not more than 1.5 times (preferably not more than 1.3 times) with respect to the film after heat setting (after the first stage of drawing in case of no heat setting). The drawing temperature in the second stage is same as in the heat setting temperature, or is about 1 to 5° C. lower than the heat setting temperature within the temperature range.

Subsequently, the film is cooled preferably with concurrent application of a slight tension to obtain a heat-shrinkable polyester film. A tensioning ratio in cooling is preferably 0.1 to 3% with respect to the film after the second stage of drawing.

In the case of process of drawing in three-stage, the heat setting process is preferably inserted between the second stage of drawing, and a third stage of drawing. Conditions of the heat setting process may be determined according to the above heat setting conditions. In addition, conditions of the third stage of drawing may also be determined according to the second stage of the drawing conditions.

From viewpoints of the heat shrinkage percentages control of the film etc., larger numbers of stages of drawing are preferable, but excessive numbers of stages make difficult a design of drawing facilities in industrial production, and therefore not more than 6 stages, and preferably not more than 4 stages are preferable.

It is preferable to use equipment that can reduce a variation in the film surface temperature in the transverse drawing process as described above. That is, the drawing process has preheating process before drawing, drawing process, heat treatment process after drawing, relaxation treatment, re-drawing process, etc. Especially, in the preheating process, the drawing process, and the heat treatment process after drawing, a range of variation of surface temperatures of the film measured at an arbitrary point is preferably in a range of the average temperature ±1° C., and preferably in a range of the average temperature ±0.5° C. The reason is that a smaller range of variation of surface temperatures of the film may give drawing and heat treatment at same temperatures over the film full length, and may equalize shrink behavior, physical properties and the like.

The film may also be drawn 1.0 to 4.0 times, preferably 1.1 to 2.0 times in a longitudinal direction, as well as uniaxially in a transverse direction by tenters. In case of biaxial drawing, either sequential or simultaneous biaxial drawing may be adopted, and additional redrawn may be performed if desired. In the sequential drawing, the film may be drawn in any of the orders of direction, from transverse to longitudinal, from longitudinal to transverse, from longitudinal, transverse and to longitudinal, and from transverse, longitudinal to transverse etc. When the film is drawn in the longitudinal direction or biaxially drawn, it is also preferable to suppress variations in the film surface temperatures as much as possible in the preheating and drawing processes, as in the transverse drawing process.

The variation in the film surface temperatures can be reduced, for example, by use of a blower mounted with an inverter allowing strict control of supply of hot air to be used for heating of the film, or by use of an equipment enabling suppression of the variation in temperatures of hot air by low-pressure steam of not more than 500 kPa (not more than 5 kgf/cm²) as a heat source.

In consideration of suppression of internal generation of heat of the film caused by drawing, and reduction of the film temperature variation in the transverse direction, a heat conductivity coefficient in the drawing process is preferably not less than 0.00377 J/cm²·sec·° C. (0.0009 calory/cm²·sec·° C.), and more preferably 0.00544 to 0.00837 J/cm²·sec·° C. (0.0013 to 0.0020 calory/cm²·sec·° C.).

Heat-Shrinkable Polyester Film Roll

The present invention includes also a heat-shrinkable polyester film wound up into a roll with a length of 1000 to 6000 m.

The present inventors etc. have examined various defects that occur in a process of producing labels, bags, etc. from the heat-shrinkable polyester film roll, and in a heat shrink process. And as a result, it was found out that these defects easily occur in case of polyesters including sub constitutional units in addition to a principal constitutional unit obtained by copolymerization or blending, not in case of homopolyesters as a raw material of the film. That is, in a longer film, when composition variation of the polyester occurred, probably this is one factor of causing variation of heat shrink behavior. And it is found out that since a heat-shrinkable polyester film roll concerning the present invention has smaller composition variation and smaller variation of heat shrink behavior the defect will not be caused.

A film having a length of not less than 1000 m is wound up into a roll in the present invention, and this is because that a long film having a length of not less than 1000 m can give uniform heat shrinkage properties in the present invention. In a shape of a roll, a film having a length of more than 6000 m is excessively large, and causes difficulty in handling.

A heat-shrinkable polyester film currently wound around a heat-shrinkable polyester film roll of the present invention shall satisfy requirements (a) to (c).

Requirement (a)

In the requirement (a), an average of heat shrinkage percentage in a maximum shrinkage direction of samples is 10% to 50%, where, the samples are obtained in a following manner:

an initiation end of a film wound in a roll of steady region giving stable film properties in a longitudinal direction is defined as a first end, and a termination end of winding thereof is defined as a second end;

a first cut-off point of samples is provided less than 2 m inside of the second end, and a final cut-off point is provided less than 2 m inside the first end;

a plurality of sample cut-off points are provided at an interval of about 100 m from the first cut-off point, and

the samples are obtained by cutting into a shape of a square measuring 10 cm×10 cm at each sample cut-off point;

wherein the samples are treated in a following manner: the samples obtained are immersed for 5 seconds in hot water at 70° C. and then withdrawn from the hot water, and subsequently immersed in water at 25° C. for 10 seconds, and then withdrawn from the water.

First, an expression, as used herein, of “steady region giving stable film properties in a longitudinal direction” of the requirements (a) will be described. The “steady region giving stable film properties in a longitudinal direction” represents an area where a film-formation process and a drawing process are stably carried out in film production, and film properties represent an almost uniform state. The present invention is based on a technical concept to equalize a composition of the polyester and other properties at a higher level than conventional levels, in a long film produced in a steady state both in the extruding and drawing processes. In actual operation, composition of the film may vary depending on a supply method of raw materials and a extruding condition employed for production thereof, and the concept of the present invention to equalize is not intended to be applied to the films that are produced in an unstable condition of material supply and/or film-formation processes. Therefore, it is assumed as a prerequisite that sampling of films for evaluation of particular properties to be equalized is conducted only in a region thereof that are produced in a stable state both in the film-formation and drawing processes, that is, in “the steady region.”

Thus, for example, when a film portion, of about 10 m length from the initiation end of winding, is not produced in the steady state, sampling will not be done in this portion, but in other portions assuming that a position 10 m from the initiation of winding will be the first end of the film.

A number of the steady regions above (steady operation regions) is usually 1 per film roll (over entire length of the film roll). However, there may be cases where such steady regions are present in multiple sites, and in such a case, sampling is conducted only in these steady regions. The steady region can be evaluated by, for example, measuring a heat shrinkage percentage in a maximum shrinkage direction of the film at 85° C. by a method described later. Namely, a region wherein a difference in the heat shrinkage percentage is in a range of not more than about 20% (a difference between a maximum value and a minimum value in a plurality of samples is not more than about 20%) may be regarded as the steady region.

Then, methods of sampling will be described. An initiation end of a film wound in a roll of steady region giving stable film properties in a longitudinal direction is defined as a first end, and a termination end of winding thereof is defined as a second end. A first cut-off point of a sample is provided less than 2 m inside of the second end, and a final cut-off point is provided less than 2 m inside the first end. A plurality of sample cut-off points are provided at an interval of about 100 m from the first cut-off point, and Samples are taken over a whole length covering the steady region at approximately regular intervals. Expression “approximately 100 m” means that a sample may be cut in a portion approximately 100 m±1 m.

The sampling method will be described in detail. For example, in a case of a roll having a heat-shrinkable film of 498 min length, and in the steady region over the entire length, a first sample No. 1 is cut from a portion of the film at not more than 2 m from the termination end of winding (the second end). An area of the sample is to be properly determined based on the properties to be measured. Subsequently, a sample No. 2 is cut at a position about 100 m from the position where the sample No. 1 is cut. Similarly, a sample No. 3 is cut at a position about 200 m, a sample No. 4 at about 300 m, and a sample No. 5 at about 400 m from the position of the first sampling. Here, since a remaining film is shorter than 100 m, a (final) sample No. 6 is cut from a portion of the film at not more than 2 m from the initiation end of winding (the first end).

In the requirement (a) for the present invention, an average of heat shrinkage percentages in a maximum shrinkage direction is 10% to 50%, wherein all the samples cut out into a shape of a square measuring 10 cm×10 cm are immersed in hot water at 70° C. for 5 seconds, and then withdrawn, and subsequently the samples are immersed in water at 25° C. for 10 seconds, and then withdrawn. Such a film can provide heat-shrinkable labels giving a high shrinkage percentage by a comparatively short-time treatment. Measuring methods and the calculating methods of the heat shrinkage percentage are performed in a same method as in a case of (A).

Same disadvantages as in the case of (A) will occur, when the heat shrinkage percentage measured under the condition (a) is less than or more than the above-mentioned range. A heat shrinkage percentage measured under the condition of (a) is more preferably not less than 15% and not more than 40%.

Requirement (b)

In requirement (b), an average of heat shrinkage percentages in a maximum shrinkage direction is not less than 75%, and the heat shrinkage percentages of all the samples are in a range of ±5% of the average heat shrinkage percentage, wherein each sample in a shape of a square measuring 10 cm×10 cm separately cut from each cut-off point of the sample in the requirement (a) is immersed in hot water at 85° C. for 5 seconds, and then withdrawn, and subsequently immersed in water at 25° C. for 10 seconds, and then withdrawn.

When the average of the heat shrinkage percentage in the maximum shrinkage direction measured under the condition of (b) is small, same disadvantages will occur as in the case (B). In addition, the average of the heat shrinkage percentages in the maximum shrinkage direction measured under condition of (b) is preferably not less than 78% and not more than 95%.

In addition, in requirement (b), heat shrinkage percentages of all the samples are also necessarily in a range of ±5% of the average heat shrinkage percentage. An equation, as used herein, “a range of average heat shrinkage percentage ±5%” means that |Q-R1| (absolute value of Q-R1) is smaller than 5 (%), and each of |Q-Rn| is smaller than 5 (%), when the heat shrinkage percentage of all the cut samples in the maximum shrinkage direction under conditions of the above (b) is measured, and the average obtained is defined as Q (%), and a heat shrinkage percentage of the sample No. 1 is defined as R1 (%). In other words, when both of the difference between Rmax as maximum of Rn and Q, and the difference between minimum Rmin and Q is in a range of ±5%, the requirement described above is to be satisfied.

Since smaller variation of the heat shrinkage percentage of the heat-shrinkable film currently wound into one roll decrease variation of heat shrink behavior of each label, bag, etc., defective products in wrapping and shrinking process will decrease, resulting in significant decrease in defective percentage of products. Variation of the heat shrinkage percentage in the requirements (b) is more preferably within a range of ±3% of the average, and more preferably within a range of ±2% of the average. Also in the heat shrinkage percentage measured in the aforementioned requirement (a), variation is preferably within a range of ±5% of the average.

In addition, an average of the heat shrinkage percentage in the orthogonal direction (heat shrinkage percentage in the orthogonal direction) is preferably not more than 10% in a maximum shrinkage direction measured under the condition (b). The value exceeding 10% easily gives visual defects by uneven shrinkage in the orthogonal direction. The average of the orthogonal direction heat shrinkage percentage measured under conditions of (b) is more preferably not more than 7%. It is desirable that not only the average but measured values of all the samples are not more than 10% (preferably not more than 7%).

Requirement (c)

A film currently wound around a heat-shrinkable polyester film roll of the present invention necessarily satisfies a requirement (c). In the requirement (c), a heat shrinkage percentage difference ΔX (%) of samples in all cut-off points represented by a following equation is in a range of 10% to 20%,
ΔX=X₀−X₁₀,

wherein, X₀ and X₁₀ are defined as follows;

X₀: a heat shrinkage percentage in a maximum shrinkage direction measured for each sample in a shape of a square measuring 10 cm×10 cm separately cut from each cut-off point of sample in requirement (a) being immersed for 5 seconds in hot water at 95° C., then withdrawn from the hot water, and subsequently, being immersed in water at 25° C. for 10 seconds, and then withdrawn from the water;

X₁₀: a heat shrinkage percentage in a maximum shrinkage direction measured in a same manner for each sample obtained by cutting into a shape of a square measuring 10 cm×10 cm after shrunk by 10% in a maximum shrinkage direction of a cut sample in a shape of a square measuring 25 cm×25 cm separately cut from each cut-off point of sample in requirement (a). The samples for measuring X₀, and the samples for measuring X₁₀ shall be cut from same cut-off points of the sample. The heat shrinkage percentages X₀ and X₁₀ are measured in a same manner as in the above (C).

Films having the above-described heat shrinkage percentage difference ΔX in the above-described range may provide heat-shrinkable labels having reinforcing effect of wrapped containers. The heat shrinkage percentage difference Δ out of the above-mentioned range gives same defects as in the above (C). More preferable heat shrinkage percentage difference ΔX is not more than 17%. A variation of the ΔX is also preferably smaller. An average of the ΔX of all samples is preferably in a range of average of ΔX±3%.

Other Properties of Long Film

In a film roll of the present invention, an average of maximum values of heat shrinkage stress of each sample measured by the aforementioned method preferably is not less than 7 MPa, the samples being cut from each cut-off point of the sample described in the requirement (a). The film having the average of the maximum value of heat shrinkage stress of not less than 7 MPa can provide heat-shrinkable labels exhibiting more excellent reinforcing effect of wrapped containers. That is, heat-shrinkable labels obtained from a film having an average of the maximum value of heat shrinkage stress less than the above-mentioned range represents tendency to deteriorate reinforcing effects of the wrapped containers. The average of the maximum value of heat shrinkage stress is more preferably not less than 10 MPa, and still more preferably not less than 11 MPa.

In addition, in a long film currently wound around into a roll, it is preferable that thickness is uniform for prevention of defective products occurrence for every label. Therefore, an average of thickness distribution is preferably not more than 6%, where the average is obtained in such a manner that thickness distribution in the maximum shrinkage direction of a film in each cut-off point of the sample is measured by the aforementioned method to calculate an average of thickness distribution of each cut-off point of the sample. An average of thickness distribution exceeding 6% gives the aforementioned disadvantages. The average of the thickness distribution is preferably not more than 3%, and especially preferably not more than 2%.

Furthermore, an average of a melting specific resistance of the samples cut from each cut-off point of sample of the long film is also preferably not more than 0.70×10⁸ Ω·cm at 275° C.

Manufacturing Method of a Long Film

Next, described will be a preferable manufacturing method of a long film having uniform composition and exhibiting uniform heat shrink behavior over a whole length.

As described above, in consideration of coexistence of heat shrinkage properties, and strength, etc. of a heat-shrinkable polyester film, blending of two or more kinds or polyester having different composition is often performed. However, in case of the aforementioned polyester blending, it has been found out that a film wound into one roll demonstrates especially large composition variation and physical properties variation. Therefore, preferably following procedures are used in order to obtain a film roll satisfying requirements (a) to (c) specified by the present invention.

(1) Equalization of Chip Shape

In blending methods, a plurality of raw polymer chips of different compositions are usually blended in a hopper and conveyed into an extruder, where the polymer is extruded in a molten state into a film. In the case where three polymer chips are used as raw polymers, for example, the chips are respectively supplied, continuously or intermittently, into 3 separate hoppers. The polymer chips are then conveyed, via a buffering hopper if necessary, finally to a hopper immediately before or above an extruder (hereinafter, referred to as a “final hopper” for convenience), wherein the chips are blended. The blended raw chips are supplied into the extruder quantitatively according to a discharge rate and then processed into a film. The present inventors have found uneven supply of raw chips, i.e., that a composition of the chips supplied from the final hopper into the extruder varies depending on a case as to whether the final hopper contains a larger amount of chips or a smaller amount of chips, based on a capacity and a shape of the final hopper. The problem is especially prominent when the polymer chips have differences in their shapes or densities, thereby resulting in variation of polyester composition of a long film to be obtained.

Therefore, in producing a heat-shrinkable polyester film roll by including a process of blending a mixture of a main polymer used in a greatest amount and one or more polymers different in compositions to the main polymers and by extruding a resulting mixture, it is preferable to adjust shapes of the plurality of the polymer chips to suppress the uneven supply of raw chips in the final hopper, as means to decrease the variation in composition of the polymer constituents in the resulting film and thus to produce a film satisfying the requirements described above, having a low variation in the properties thereof.

Raw chips for polyester films are usually produced in a process wherein a polyester in a molten state after polymerization is extruded as strands, which are immediately chilled in water and cut with a strand cutter. Therefore, the polyester chips have usually a cylindrical shape with an elliptical cross section. The present inventors have found that incidence of uneven supply of raw polyester chips as described above can be reduced, when average major and minor axes (mm) of the elliptic cross section and average lengths of the raw polyester chips of minor constituents to be blended with the polyester chips of the main constituent are, respectively, in ranges of the average ±20% of those of the major constituent raw chips. More preferably, those values are, respectively, within ranges of the average ±15%.

When there is a large difference in a size of chips, smaller chips tend to sink during the chips being moved downward in the final hopper, making the ratio of the larger chips located higher when an amount of the remaining chips in the final hopper becomes smaller, thus resulting in uneven supply of raw materials. However, use of the chips fulfilling the requirement above, the uneven supply of the raw materials can be reduced and consequently a long film having a uniform film composition may be obtained.

(2) Optimization of Hopper Shape

While an extruder is used for producing a film, optimization of a shape of the final hopper is also a preferable means for obtaining a film having a uniform composition. Namely, when an inclination angle of a funnel-shaped hopper is smaller than 65°, only small chips can move downward, resulting in uneven supply of the raw materials. Use of a hopper having the inclination angle of not less than 65°, it becomes easy to similarly move both of larger and smaller chips downward in the hopper, keeping the upper edge of contents (chips) horizontal, and reducing the uneven supply of raw materials. The inclination angle is more preferably not less than 70°. Here, the inclination angle of the hopper represents an angle between an oblique line of the hopper and a horizontal line. A plurality of hoppers may be installed upstream to the final hopper, and in such a case, the inclination angles of all the hoppers are preferably not less than 65°, and more preferably not less than 70°.

(3) Optimization of Hopper Capacity

As means for reducing the uneven supply of raw materials in the hopper, it is also advantageous to optimize a hopper volume. An optimal capacity of the hopper is in a range of 15 mass % to 120 mass % of a discharge of an extruder per hour. It is due to the fact that with a hopper without a capacity of about not less than 15 mass %, stable supply of the raw materials will become difficult, while in a hopper having an excessively larger capacity, the raw chip mixture stays in the hopper over a long time, possibly causing the uneven supply of the chips. Therefore, the hopper volume is more preferably in a range of 20 mass % to 100 mass % of the discharge of the extruder per hour.

(4) Reduction of Fine Powders

It is also advantageous to reduce an amount of fine powders formed by mutual grinding of chips etc., for obtaining a long film having a uniform composition. Since the fine powders also contribute for incidence of raw material uneven supply, it is preferable to remove the fine powders formed in production processes, and to reduce an amount of the fine powders in the hopper. A ratio of the fine powders in the raw material (100%), is preferable to be controlled not more than 1 mass %, throughout the processes before the raw chip reaches the extruder, more preferably not more than 0.5 mass %. Specifically, the fine powders can be removed, for example, by sieving the chips and by air conveying the raw chips via a cyclone air filter after chopping the chips with a strand cutter.

(5) Equalization of Surface Temperature of Films in Drawing Process

Factors causing a variation in heat shrinkage properties of a long film include a variation in operational parameters in the drawing process, as well as a variation in the polymer compositions constituting the film described above. Therefore, it is preferable to control a variation of temperature in the drawing process and thus to reduce the variation in surface temperature of the film being drawn as much as possible.

In case of uniaxial drawing of a polyester film in a transverse direction with a tenter, there are processes; a preheat process before drawing, a drawing process, a heat-treating process after drawing, a relaxation process, and a redrawing process, etc. Especially, heat control in the preheating process, the drawing process, and the heat-treating process after the drawing process is essential and it is preferable to control a variation of surface temperatures of the film measured at any point in these processes above in a range of the average temperature ±1° C., for producing the film having uniform heat shrinkage properties. It is more preferable to control the temperature in a range of the average temperature ±0.5° C.

Variations in temperature in the preheating, drawing, and heat-treating processes greatly affect the variation in the heat shrinkage percentages (in a maximum shrinkage direction as well as a direction orthogonal thereto) and a maximum values of the heat shrinkage stress of the resulting drawn film. Therefore, a smaller variation in the surface temperature of the film in these processes make uniform the heat shrinkage properties of the drawn film, since the film is drawn and heat-treated at a same temperature over an entire length. It is needless to say that smaller variations in surface temperature of the film during the relaxation and redrawing processes are also preferable.

The variation in the film surface temperatures can be reduced, for example, by using a blower mounted with an inverter that can strictly control the supply of the hot air to be used for heating of the film, or by using an equipment that can suppress a variation in temperature of the hot air by use of low-pressure steam of not more than 500 kPa (not more than 5 kgf/cm²) as a heat source, as described above.

A variation in the surface temperature of the film measured at any point is a variation in the surface temperature of the film measured continuously during production thereof at a point, for example, 2 m from an entrance of the drawing process by using e.g., a non-contact infrared type surface thermometer. After production of 1 roll of film, average temperatures can be calculated. When a resulting variation in the film surface temperature fall in a range of average temperature ±1° C., the film is regarded to be drawn in a same condition over an entire length of the film in a steady region, and to be low in variation in the heat shrinkage properties.

In order to equalize composition of the long film and to suppress variation of heat shrink behavior, preferable is adoption of all of the procedures (1) to (5). Accordingly, it is preferable to extrude a film, by reducing fine powders by the procedure (4), by using raw chips in sizes defined in the procedure (1), by blending each raw chips in a hopper having a inclination angle of not less than 65° as described in the procedure (2), and having a volume fulfilling the requirement in the procedure (3), by supplying the blended chips continuously into an extruder, and by extruding at a controlled discharge rate, and it is desirable to perform the drawing process, after temperature management has been precisely carried out by the procedure (5). Additionally, the raw chips may be premixed and fed, via intermediate (buffer) hoppers, to the final hopper, and then supplied to the extruder. A plurality of raw chips may be blended in a hopper by quantitatively supplying the raw chips thereinto, or premixed, for example, by use of a blender etc. In the latter case, it is preferable to pay attention to a size of the raw chips so that the uneven supply of the mixture may not happen during discharge.

A film of heat-shrinkable polyester film roll in the present invention preferably has a length of 1000 to 6000 m, and has a width of not less than 0.2 m. A roll of film having width less than 0.2 m has industrially low utility value. In addition, since a roll of film having a length less than 1000 m has a little volume length of the film, a variation of composition and heat shrink behavior over a full length of the film naturally becomes smaller, and effects of the present invention will become difficult to be developed. A width of the heat-shrinkable polyester film roll of the present invention is preferably not less than 0.3 m, and more preferably not less than 0.4 m.

Upper limits of the width and the roll length of the film roll is not especially limited, and in view of easy handling, the roll of the present invention in general preferably has a width of not more than 1.5 m, and, for example, a roll length of not more than 6000 m. As a rolling up core, plastics cores, metal cores, or paper tubes, such as of 3 inches, 6 inches, and 8 inches, may usually be used.

A thickness of the film constituting the heat-shrinkable polyester film roll of the present invention is not especially limited. For example, as a heat-shrinkable polyester film for labels, the thickness is preferably 10 μm to 200 μm, more preferably 20 μm to 100 μm, and still more preferably 20 μm to 60 μm.

The heat-shrinkable label obtained using the heat-shrinkable polyester film of the present invention may present excellent shrinking finished visual appearance also in usage (labels needs partially higher shrinkage percentage) of full labels, such as for PET bottles, furthermore leading to realization of higher shrinkage percentage in a shorter-time treatment. Furthermore, it also has reinforcing effects of containers, such as PET bottles that are wrapped and shrunk.

The heat-shrinkable label obtained using the heat-shrinkable polyester film wound into a roll of the present invention, may exhibit excellent heat shrinkage properties, and furthermore may provide a smaller variation to heat shrink behavior of each label, and realize an extremely smaller rate of incidence of defective products.

For obtaining a heat-shrinkable label using the heat-shrinkable polyester film preferably following procedures are used. For example, a heat-shrinkable film roll before shrinking is taken out after predetermined period of time storage in an environment of controlled temperature and humidity. A solvent for adhesion is applied, while the film is unwound film from the roll, with a specified width a little inside from one edge of one surface thereof by a conventionally known tubing machine, and immediately the film is folded so that the edges thereof are adhered to each other, thus yielding a tubular film. The tubular film obtained is flattened and wound into a roll, or cut into a predetermined length continuously after tubing processing to obtain a heat-shrinkable label.

A melt adhesion method of partially melting a film may be adopted as adhesion of the film, but use of solvent is preferable from a viewpoint of suppression, such as variation of the heat shrinkage properties of labels. Solvents suitably used include, for example, organic solvents such as: aromatic hydrocarbons, such as benzene, toluene, xylene, and trimethyl benzene; halogenated hydrocarbons, such as methylene chloride and chloroform; phenols, such as phenol; furans, such as tetrahydrofuran; oxolanes, such as 1,3-dioxolane; etc. Especially, 1,3-dioxolane is desirable for higher safety.

After wrapping onto containers, such as PET bottles, the heat-shrinkable label may be heat-shrunk with the above-described publicly known heat shrink means (hot-air tunnels, steam tunnels, etc.)

In PET bottles wrapped and shrunk with the heat-shrinkable label of the present invention, even when the bottles have a weight about 30% smaller than conventional PET bottles, the bottles may be reinforced in such a level to enable handling in a same manner as in conventional PET bottles, for example, in transportation and selling. In this case, not less than 75% of a drum section surface area of the PET bottle is preferably covered with the label.

For example, in labels produced from the heat-shrinkable film of the present invention in following manners, a rate of change in a bottle diameter measured by a method mentioned later is preferably not more than 10%, and more preferably not more than 7%, enabling demonstration of excellent container reinforcing effect.

A film is coated with 1,3-dioxolane in a line with a 3±1 mm width, a little inside from one edge of one surface thereof (coating amount: 3.0±0.3 g/m²), both edges of the film is folded to be adhered to each other, and then cut in a size of 14 cm in length, and 6.7 cm in diameter to obtain a cylindrical label. A round shape PET bottle having a volume of 500 mL with a mass of 20.5 g [21 cm in height, and 6.5 cm in diameter of a central part (drum section)] is filled with water 500 mL, and sealed. This bottle is wrapped with the cylindrical label, and is passed in a steam tunnel with a zone temperature of 85° C. in 2.5 seconds to shrink the label. Onto a central part of a side face of the label-wrapped bottle thus obtained, 15 kg of load is applied in compression mode using “Strograph V10-C” made by ToyoSeiki. A diameter (W₁) of the bottle central part at this time is measured. A rate of change in a bottle diameter (%) is calculated according to a following equation.
Rate of change in a bottle diameter(%)=100×(W₁−W₂)/W₂
Here, W₂ represents a diameter of the bottle central part before application of a load.

For example, when a label-wrapped bottle falls within a vending machine, since a label having the rate of change in a bottle diameter exceeding 10% disadvantageously tends to allow deformation of the container and may cause clogging.

Hereinafter, the present invention will be described in detail in reference to examples, these examples are not intended to limit the scope of the present invention, and modifications within the spirit and scope of the present invention are also included by the present invention. Physical properties of films obtained in examples are determined according to following methods.

(1) Heat Shrinkage Percentage

A film is cut into a square measuring 10 cm×10 cm, and is immersed for 5 seconds in a no-load state in hot water with temperatures of following (A), (B), and (C) to be heat shrunk. The film is then immersed in water at 25° C.±0.5° C. for 10 seconds, and withdrawn from the water. Lengths in lengthwise and transverse direction are measured to obtain the heat shrinkage percentage according to a following equation.
Heat shrinkage percentage (%)=100×(length before shrinking-length after shrinking)/(length before shrinking)
Here,
(A): 75° C.±0.5° C.,
(B): 85° C.±0.5° C.,
(C): 95° C.±0.5° C.

A direction giving a largest shrinkage percentage is defined as a maximum shrinkage direction.

(2) Heat Shrinkage Percentage Difference

A gripping device having two chucks facing each other is prepared so as to enable gripping of only a pair of edge of a rectangular film. A heat-shrinkable polyester film is cut into a square or a rectangle in parallel with respect to the maximum shrinkage direction. The film after cut is fixed with the gripping device. Both ends orthogonal to the maximum shrinkage direction of film are gripped with the chuck, and the film is loosened to give a ratio between a length of the film between the chucks and a distance between chucks of 1:0.9. Subsequently, the film fixed to the device is immersed in hot water at 95° C.±0.5° C. in a no-load state, for 5 seconds, and is heat shrink, and the film is immediately immersed in water at 25° C.±0.5° C. for 10 seconds in a no-load state, and then withdrawn out from the water. This film is withdrawn from the device, and water is removed to obtain a film having experienced 10% of heat shrink in the maximum shrinkage direction. Subsequently, this film is placed in air and under environment of not more than 25° C. in unstrained state, and subjected as immediately as possible to following process.

This film is cut into a square measuring 10 cm×10 cm, immersed in hot water at 95° C.±0.5° C. for 5 seconds in a no-load state to experience heat shrink, and then immersed in water at 25° C.±0.5° C. for 10 seconds. The film is withdrawn from the water and lengths in lengthwise and transverse direction are measured to obtain heat shrinkage percentages in a maximum shrinkage direction X₁₀ according to the heat shrinkage percentage equation. Furthermore, a heat shrinkage percentage in a maximum shrinkage direction determined by the temperature condition of (C) of (1) is defined as X₀. From these values, a heat shrinkage percentage difference ΔX (%) is calculated according to a following equation.
ΔX=X₀−X₁₀
(3) Three-Dimensional Surface Roughness SΔa, SRz

A surface of a sample film is probed with a needle along MD of the film. (measurement length: 1 mm, cutoff value: 0.25 mm). A needle type three-dimensional roughness gauge (product of Kosaka Seisakusho “ET-30K”) is used for probing. (Radius of needle: 2 μm, load: 30 mg). A projections and depressions profile with a length of 1 mm obtained by this probing is divided into 500 points in a pitch of 2 μm, and heights of each point are inputted to a three-dimensional roughness analysis device (product of Kosaka Seisakusho “AT-30K”). A same operation as described above is continuously performed in TD of the film 150 times at intervals of 2 μm (that is, over 0.3 mm in TD of the film). Calculation with the analysis device gives SΔa and SRz.

(4) Maximum Value of Heat Shrinkage Stress

The maximum value of heat shrinkage stress is measured using a tensile testing machine with a hot-air oven (“Tensilon” manufactured by Toyoseiki). From a film before heat shrinking, cut is a specimen with a length of 200 mm in the maximum shrinkage direction and a width of 20 mm. Air supply of the hot-air oven beforehand heated at 90° C. is terminated. A distance between corresponding chucks is set as 100 mm. The specimen is fixed to the chucks being loosened to give a ratio between a length of the specimen between chucks and a distance between chucks of 1:0.9. A door of the oven is closed immediately, and air supply is resumed (at a temperature of 90° C. and a air velocity of 5 m/second, hot air is delivered from 3 directions of back, left, and right.) A shrinking stress detected at this time is measured, and a maximum value of heat shrinkage stress (MPa) after 10% shrinking is determined from a measurement chart.

(5) Thickness Distribution

Ten specimens, 50 cm in length and 5 cm in width, having a maximum shrinkage direction of a film as a longitudinal direction are prepared. Each specimen is continuously measured for a thickness in a longitudinal direction using a contact type thickness gage, for example, “KG60/A” (by ANRITSU CORP. etc.) to output into a chart. A maximum thickness, a minimum thickness, and an average thickness are obtained from this output. After calculating a thickness distribution using a following equation from the above-described data, an average of thickness distribution of 10 specimens is determined to give a thickness distribution of film.
Thickness distribution=[(maximum thickness−minimum thickness)/average thickness]×100
(6) Melting Specific Resistance

A pair of electrode plates is inserted in a sample (film) molten at a temperature of 275° C. to apply a voltage of 120 V. An electric current in the case is measured, and a melting specific resistance Si (Ω·cm) is calculated by a following equation.
Si=(A/I)×(V/io)
Here,
A: Area of electrode (cm²),
I: Inter-electrode distance (cm),
V: Voltage (V),
io: Electric current (A)
(7) Quality after Shrink-Finishing

Three-color printing with green, gold, and white is performed to a film using inks manufactured by TOYO INK MFG. CO., LTD. The film is removed out after storage of 250 hours in an environment controlled at a temperature of 30° C.±1° C., and 85%±2% of relative humidity. The film is coated with 1,3-dioxolane in a line with a 2±1 mm width, a little inside from one edge of one surface thereof (coating amount: 3.0±0.3 g/m²), and immediately the film is folded to give a tube so that the edges thereof are adhered to each other. The tubular film is flattened and rewound into a roll. This tube is cut out to obtain a cylindrical label with 14 cm in height and 6.7 cm in diameter. Round shaped PET bottles of 500 mL filled with water [21 cm in height, and central part (drum section) 6.5 cm in diameter] are wrapped with this label. The resultant label-wrapped PET bottles are moved through a steam tunnel manufactured by Fuji Astec Inc., (Type: SH-1500-L) under conditions of a staying period in the tunnel of 2.5 seconds and temperature of zone of 85° C. Thus, labels are shrunk (n=20). Level of shrinking finish is visually inspected, and quality after shrink-finishing is evaluated in two stages.

Criteria;

◯: both crinkling, jump, and insufficient shrinkage not observed,

x: Crinkling, jump, or insufficient shrinkage observed.

(8) Container Reinforcing Effect

Using a tube molding equipment, 1,3-dioxolane is coated in a line of a 3±1 mm width, a little inside from one edge of one surface of a film, (coating amount: 3.0±0.3 g/m²), and immediately the film is folded to make both edges superimposed and adhered to each other, yielding a tubular film. The tubular film is flattened and rewound into a roll. This tube is cut out to obtain a cylindrical label with 14 cm in height and 6.7 cm in diameter. Round shaped PET bottles of 500 mL filled with water [21 cm in height, and central part (drum section) 6.5 cm in diameter] are wrapped with this label. The resultant label-wrapped PET bottles are moved through a steam tunnel manufactured by Fuji Astec Inc., (Type: SH-1500-L) under conditions of a staying period in the tunnel of 2.5 seconds and temperatures of zone of 85° C. Thus, labels are shrunk. Onto a central part of a side face of the label-wrapped bottle thus obtained, 15 kg of load is applied in compression mode using “Strograph V10-C” made by ToyoSeiki. A diameter (W₁) of the bottle central part at this time is measured. A rate of change in a bottle diameter (%) is calculated according to a following equation.
Rate of change in a bottle diameter(%)=100×(W₁−W₂)/W₂
Here, W₂ represents a diameter of the bottle central part before application of a load.
(9) Blocking Resistance

In a hot state immediately after examination, all label wrapped PET bottles obtained by the quality after shrink-finishing examination are sequentially boxed into a carton box (3×4=12 as one set) so that labels may contact. This carton box is removed out after 24-hour storage in interior of a room controlled by 40° C.±1° C. Level of blocking of labels is evaluated by three-stage.

Evaluation criterion;

◯: blocking not observed,

Δ: blocking observed, but when detached, no mark remains

x: blocking observed, and when detached, mark remains.

◯ and Δ: passed.

(10) Transferring Property and Tear Resistance of Film

The film is slit into width: 100 mm and length: 100 m to give shape of a tape. After rolling up this tape into a roll, the tape is delivered out from this roll, extended on metal guide rolls located in a line at intervals of 0.2 m, and then connected to a wind-up roll. Subsequently, all of the tape is made to run by 100 m/minute in velocity, and wound up on the wind-up roll. An amount of abrasion mark and an amount of white powder of the tape deposited on a surface of the guide roll after transferring are visually observed to evaluate according to following criteria.

[Transferring Property]

1: quite many abrasion marks,

2: many abrasion marks,

3: a little abrasion mark

4: almost no abrasion marks, and

5: no abrasion mark,

[Tear Resistance]

1: formation of very much white powder,

2: formation of much white powder,

3: formation of a little white powder,

4: almost no white powder,

5: no white powder.

### SYNTHESIS EXAMPLE 1

Into an esterification reaction vessel, introduced are dimethylterephthalate 100 mole % as polybasic carboxylic acid, and ethylene glycol 100 mole % as polyhydric alcohol with 2.2 times (molar ratio) with respect to the polybasic carboxylic acid. Also simultaneously, introduced are antimony trioxide 0.04 mole % with respect to the polybasic carboxylic acid as a catalyst, and magnesium acetate 4 hydrate at 81 ppm in terms of Mg atom with respect to a polyester formed. The system temperature was raised to 230° C., with agitation to perform an ester interchange reaction at normal pressure for 120 minutes. Termination of ester interchange reaction was considered as a timing of a specified quantity of methanol distilled off. After termination of the ester interchange reaction, trimethyl phosphate was added so as to give 58 ppm in terms of P atom with respect to the polyester formed. The system temperature was raised to 280° C., under reduced pressure over 85 minutes, to perform polycondensation reaction approximately for 40 minutes until melt viscosity gives 7000 poise, obtaining a polyester A.

### SYNTHESIS EXAMPLES 2 TO 7

In a same manner as in Synthesis example 1, polyesters B to G represented in Table 1 were synthesized. In Synthesis examples 2 and 3, polyesters B and C were obtained using antimony trioxide so that Sb atom might give 160 ppm with respect to the polyester as a polymerization catalyst. In addition, in Synthesis example 4, polyester D was obtained using titanium tetrabutoxide so that Ti atoms give 90 ppm with respect to polyester as a polymerization catalyst. Furthermore, in Synthesis example 6, polyester F was obtained using cobalt acetate tetra hydrate so that Mg atom gives 20 ppm with respect to polyester as a polymerization catalyst, and furthermore using titanium tetrabutoxide so that Ti atoms may give 15 ppm with respect to polyester as a polymerization catalyst. In Synthesis example 7, polyester G was obtained using a same polymerization catalyst as in Synthesis example 1.

As a lubricant, silica having a mean particle diameter of 1.8 μm (manufactured by Fuji Silysia Chemical LTD. “Sisilia 350”), silica having a mean particle diameter of 0.007 μm, or silica having a mean particle diameter of 5.80 μm were added by 0.7 mass % in polyester A or polyester E, respectively to obtain a master batch, and the master batch was to be added to films.

Production of polyester A or polyester E including the silica blended therein was performed in such a manner that the silica was dispersed into ethylene glycol in polymerization thereof. Incidentally, silica in each film excluding the below-mentioned film No. 5 (experiment 5) was introduced with a silica blended polyester A, and the silica in the film No. 5 was introduced with the silica blended polyester E.

Table 1 shows polyesters A to G obtained in the Synthesis example 1 to 7. In Table 1,

DMT: dimethyl terephthalate,

DMN: dimethyl naphthalate,

EG: ethylene glycol,

NPG: neopentyl glycol,

BD: 1,4-butanediol,

CHDM: 1,4-cyclohexane dimethanol,

PPG: 1,3-propanediol.

TABLE 1

| | Preparation composition | | | | | | |
|---|---|---|---|---|---|---|---|
| | Dicarboxylic | | | | | | |
| | acids (mole %) | | Dihydric alcohols (mole %) | | | | |
| Polyester | DMT | DMN | EG | NPG | BD | CHDM | PPG |
| A | 100 | | 100 | — | — | — | — |
| B | 100 | | 70 | 30 | — | — | — |
| C | 100 | | 60 | 40 | — | — | — |
| D | 100 | | — | — | 100 | — | — |
| E | — | 100 | 100 | — | — | — | — |
| F | 100 | | 70 | — | — | 30 | — |
| G | 100 | | — | — | — | — | 100 |

Experimental Result about Heat-Shrinkable Polyester Film
Experiment 1

Each chip of polyester A, silica blended polyester A, polyester chip B and polyester D, each separately pre dried, respectively, were blended at percentages represented in Table 2, and then were melt extruded with a monoaxial extruder (with T die) at 280° C., and subsequently cooled with casting rolls immediately to obtain an undrawn film having a thickness of 260 μm. The undrawn film was drawn in a transverse direction (a film width direction) after preheating at 100° C. for 3 seconds with a tenter.

The film was drawn by 4.75 times first at 77° C. (a first stage), then was tensed by 3% at 77° C. with respect to the film width at the time of termination of the first stage for 5 seconds (heat setting), and subsequently, drawn at 75° C. by 1.1 times the film width at the time of termination of the heat setting (the second stage). Subsequently, the film was cooled while applying 1% of tension to a film width after termination of drawing of the second stage, and a polyester film No. 1 with a thickness of 50 μm was obtained. Tables 4 and 5 represent evaluation results of the obtained film.

Experiments 2 to 7

Except for having changed mixing ratios of polyester chips, as represented in Table 2, undrawn films with a thickness of 260 μm were obtained in a same manner as in experiment 1. The films were drawn in a same manner as in experiment 1 except for conditions represented in Table 3, and polyester films No. 2 to 7 having a thickness of 50 μm were obtained. Tables 4 and 5 represent evaluation results of each obtained film.

Experiment 8

Produced was a laminated polyester film No. 8 having three layers comprising both outer layers and a central layer. In the central layer of this laminated polyester film, each separately pre dried chip of polyester A, polyester C, and polyester D, respectively, was used to be blended at percentages represented in Table 2. In addition, in both outer layers, each separately pre dried chip of polyester A, silica blended polyester A, and polyester F, respectively, was used to be blended at percentages represented in Table 2. These mixed polyester chips were co-extruded at 280° C. using a monoaxial extruder having a T die, and then cooled with casting rolls immediately. Thus, obtained was an undrawn film with three-layered structure having both outer layers having a thickness of 65 μm and the central layer having a thickness of 130 μm, respectively. This undrawn film was drawn in a same manner as in experiment 1 except for having changed into conditions represented in Table 3, and a polyester films No. 8 a thickness of 50 μm was obtained (both outer layers with a thickness of 12.5 μm, respectively, and the central layer with a thickness of 25 μm.) Tables 4 and 5 represent evaluation result of obtained films.

Experiments 9 to 11

Except for having changed mixing ratios of polyester chips, as represented in Table 2, undrawn films having a thickness of 260 μm were obtained in a same manner as in Experiment 1. The undrawn films were drawn in a same manner as in experiment 1 except for having changed into conditions represented in Table 3 to obtain polyester films No. 9 to 11 having a thickness of 50 μm. Tables 4 and 5 represent evaluation results of obtained films.

TABLE 2

| | | | Polyester mixing | | | | | | | Silica particle | |
|---|---|---|---|---|---|---|---|---|---|---|---|
| Film | Layer | | composition (mass part) | | | | | | | Mean particle | Amount of |
| No. | composition | | A | B | C | D | E | F | G | diameter (μm) | addition (mass %) |
| No. 1 | Single layer | | 15 | 75 | — | 10 | — | — | — | 1.80 | 0.04 |
| No. 2 | Single layer | | 10 | 80 | — | 10 | — | — | — | 1.80 | 0.04 |
| No. 3 | Single layer | | 15 | 80 | — | 5 | — | — | — | 1.80 | 0.04 |
| No. 4 | Single layer | | 15 | — | 75 | 10 | — | — | — | 1.80 | 0.04 |
| No. 5 | Single layer | | — | — | — | 15 | 85 | — | — | 1.80 | 0.04 |
| No. 6 | Single layer | | 15 | — | — | — | — | 85 | — | 1.80 | 0.06 |
| No. 7 | Single layer | | 15 | — | 75 | — | — | — | 10 | 1.80 | 0.04 |
| No. 8 | Three- | Central | 15 | — | 75 | 10 | — | — | — | — | — |
| | layered | layer | | | | | | | | | |
| | | Both | 15 | — | — | — | — | 85 | — | 1.80 | 0.04 |
| | | outer | | | | | | | | | |
| | | layers | | | | | | | | | |

| | | | | | | | | | | |
|---|---|---|---|---|---|---|---|---|---|---|
| No. 9 | Single layer | 40 | — | 50 | 10 | — | — | — | 1.80 | 0.06 |
| No. 10 | Single layer | 15 | 75 | — | 10 | — | — | — | 0.007 | 1.00 |
| No. 11 | Single layer | 15 | 75 | — | 10 | — | — | — | 5.80 | 0.04 |

When silica is blended in a film or a layer constituting the film in Table 2, an amount of polyester A in Table 2 represents a total amount of the amount of the polyester A chips and the polyester A in the silica blended polyester A chip, and an amount of polyester E in Table 2 represents a total amount of the amount of the polyester E chips, and the polyester E in the silica blended polyester E chip. In addition, in the case of a single layer film, “silica particle” represents a content to the film whole quantity, and in the case of three-layered film, “silica particle” represents a content to each outermost layer whole quantity.

TABLE 3

| | Drawing conditions | | | | | | | |
|---|---|---|---|---|---|---|---|---|
| | First stage of | | | | | Second stage of | | Tensioning |
| | drawing | | Heat setting | | | drawing | | ratio in |
| Film | Ratio | Temperature | Tensioning | Temperature | Period | Ratio | Temperature | cooling |
| No. | (time) | (° C.) | ratio (%) | (° C.) | (second) | (time) | (° C.) | (%) |
| No. 1 | 4.75 | 77 | 3 | 77 | 5 | 1.1 | 75 | 1 |
| No. 2 | 4.75 | 77 | 3 | 77 | 5 | 1.1 | 75 | 1 |
| No. 3 | 4.75 | 80 | 3 | 80 | 5 | 1.1 | 78 | 1 |
| No. 4 | 4.75 | 78 | 0 | — | — | 1.1 | 78 | 0 |
| No. 5 | 4.75 | 95 | 3 | 75 | 5 | 1.1 | 75 | 1 |
| No. 6 | 4.75 | 80 | 3 | 75 | 5 | 1.1 | 75 | 1 |
| No. 7 | 4.75 | 77 | 3 | 77 | 5 | 1.1 | 75 | 1 |
| No. 8 | 4.75 | 78 | 3 | 75 | 5 | 1.1 | 75 | 1 |
| No. 9 | 4.75 | 84 | 0 | — | — | 1.1 | 77 | 0 |
| No. 10 | 4.75 | 77 | 3 | 77 | 5 | 1.1 | 75 | 1 |
| No. 11 | 4.75 | 77 | 3 | 77 | 5 | 1.1 | 75 | 1 |

In Table 3, a drawing ratio in the first stage of drawing represents a ratio to a film width, a tensioning ratio in heat setting represents a ratio to a film width after the first stage of drawing, a drawing ratio in the second stage of drawing represents a ratio to a film width after heat setting (after the first stage of drawing in case without heat setting), and a tensioning ratio in cooling represents a ratio to a film width after the second stage of drawing. In addition, in films No. 4 and 9, the tensioning ratio “0%” in heat setting represents a case without heat setting process, and a tensioning ratio “0%” in cooling represents that the film was cooled without stress after the second stage of drawing.

TABLE 4

| | Heat shrinkage percentage (%) | | | | | |
|---|---|---|---|---|---|---|
| | | (B) | | | | |
| | | Maximum | | Heat shrinkage | | |
| Film | | shrinkage | orthogonal | percentage | | SRz |
| No. | (A) | direction | direction | difference ΔX (%) | SΔa | (μm) |
| No. 1 | 50 | 78 | −1 | 10 | 0.012 | 0.74 |
| No. 2 | 30 | 78 | −3 | 11 | 0.012 | 0.75 |
| No. 3 | 43 | 78 | −3 | 11 | 0.011 | 0.74 |
| No. 4 | 30 | 76 | −2 | 15 | 0.014 | 0.79 |
| No. 5 | 15 | 76 | 2 | 15 | 0.013 | 0.77 |
| No. 6 | 13 | 76 | −1 | 16 | 0.012 | 0.75 |
| No. 7 | 42 | 77 | 1 | 11 | 0.012 | 0.77 |
| No. 8 | 45 | 78 | 0 | 10 | 0.012 | 0.78 |
| No. 9 | 20 | 70 | 1 | 30 | 0.017 | 0.88 |
| No. 10 | 50 | 78 | −1 | 10 | 0.007 | 0.53 |
| No. 11 | 50 | 78 | −1 | 10 | 0.037 | 1.65 |

| | Maximum value of | | | Melting specific | Rate of change in |
|---|---|---|---|---|---|
| Film | heat shrinkage | Quality after | Thickness | resistance | a bottle |
| No. | stress (MPa) | shrink-finishing | distribution (%) | (× 10⁸ Ω · cm) | diameter (%) |
| No. 1 | 12 | ∘ | 0.8 | 0.32 | 6.0 |
| No. 2 | 12 | ∘ | 0.9 | 0.27 | 6.1 |
| No. 3 | 14 | ∘ | 0.7 | 0.31 | 5.9 |
| No. 4 | 8 | ∘ | 1.3 | 0.32 | 6.7 |
| No. 5 | 10 | ∘ | 1.0 | 0.65 | 6.5 |
| No. 6 | 14 | ∘ | 0.9 | 0.31 | 5.9 |
| No. 7 | 11 | ∘ | 1.1 | 0.41 | 6.3 |
| No. 8 | 12 | ∘ | 1.0 | 0.32 | 6.0 |
| No. 9 | 5 | x | 2.0 | 0.55 | 10.2 |
| No. 10 | 12 | ∘ | 0.8 | 0.32 | 6.0 |
| No. 11 | 12 | ∘ | 0.8 | 0.32 | 6.0 |

TABLE 5

| | Blocking | Transferring | Tear |
|---|---|---|---|
| Film number | resistance | property | resistance |
| No. 1 | ∘ | 4 | 5 |
| No. 2 | ◯ | 4 | 5 |
| No. 3 | ◯ | 4 | 5 |
| No. 4 | ◯ | 4 | 5 |
| No. 5 | ◯ | 4 | 5 |
| No. 6 | ◯ | 4 | 5 |
| No. 7 | ◯ | 4 | 5 |
| No. 8 | ◯ | 4 | 5 |
| No. 9 | ◯ | 4 | 5 |
| No. 10 | X | 1 | 5 |
| No. 11 | ◯ | 5 | 1 |

### SYNTHESIS EXAMPLE 8 TO 14

Polyesters A to G were synthesized in a same manner as in Synthesis example 1 except for not having blended silica in the polyester A and the polyester E. The polyesters have same compositions as that of the polyesters A to G of Table 1.

Experiment 12

Produced was a laminated polyester film No. 12 having three layers comprising both outer layers and a central layer. In the central layer of this laminated polyester film, each separately pre dried chip of the polyester A, the polyester B, and the polyester D, respectively, were used to be blended at percentages represented in Table 6. Into the mixed polyester, an ultraviolet radiation cutting agent (manufactured by Ciba Specialty Chemicals) Tinuvin® 326) was added so that the ultraviolet radiation cutting agent might give 1 mass % in a total of 100 mass % of the mixed polyester and the ultraviolet radiation cutting agent. In addition, a mixture of the mixed polyester and the ultraviolet radiation cutting agent having a same composition as in the central layer was used also for both outer layers. The mixed polyester chip were co-extruded at 280° C. using a monoaxial extruder having a T die, and then cooled with casting rolls immediately. Obtained was an undrawn film with a three-layered structure having thicknesses of both outer layers of 65 μm, respectively, and a thickness of the central layer of 130 μm. After preheating for 3 seconds at 100° C., this undrawn film was drawn in a tenter in a transverse direction (the film width direction). The film was drawn by 4.75 times first at 77° C. (a first stage), then was tensed by 3% at 77° C. with respect to a film width at the time of termination of the first stage for 5 seconds (heat setting), and subsequently, drawn at 75° C. by 1.1 times the film width at the time of termination of the heat setting (the second stage). Subsequently, the film was cooled while applying 1% of tension to a film width after termination of drawing of the second stage. A polyester film No. 12 having a thickness of 50 μm was obtained (thicknesses of both of the outer layers 12.5 μm, respectively, and a thickness of the central layer of 25 μm). Table 8 represents evaluation results of the obtained film.

Experiments 13 to 19

Except for having changed mixing ratios of polyester chips, and kinds and amounts of addition of ultraviolet radiation cutting agents, as represented in Table 6, undrawn films having a thickness of 260 μm (thicknesses of both outer layers of 65 μm, respectively, and a thickness of central layer of 130 μm) was obtained in a same manner as in Experiment 12. Except for having changed into conditions represented in Table 7, in a same manner as in experiment 12, the undrawn films were drawn to obtain polyester films No. 13 to 19 having a thickness of 50 μm (thicknesses of both outer layers of 12.5 μm, respectively, and a thickness of central layer of 25 μm). “Bonasorb 3901” used in experiment 16 is an ultraviolet radiation cutting agent manufactured by Orient chemical Industries, Ltd., and “Novapex® U110” used in experiment 17 is an ultraviolet radiation cutting agent manufactured by Mitsubishi Chemical Corporation. Table 8 represents evaluation results of obtained films.

Experiment 20

Except for having changed a mixing ratio of the polyester chips, as represented in Table 6, and for not having used the ultraviolet radiation cutting agent in any of central layer and both outer layers, in a same manner as in Experiment 12, obtained was an undrawn film having a thickness of 260 μm (thicknesses of both outer layers of 65 μm, respectively, and a thickness of central layer of 130 μm). Except for having changed into conditions represented in Table 7, in a same manner as in Experiment 12, the undrawn film was drawn to obtain a polyester film No. 20 having a thickness of 50 μm (thicknesses of both outer layers of 12.5 μm, respectively, and a thickness of central layer of 25 μm). Table 8 represents evaluation results of obtained films.

Experiment 21

Except for not having used the ultraviolet radiation cutting agent in any of central layer and both outer layers, in a same manner as in Experiment 12, an undrawn film having a thickness of 200 μm (thicknesses of both outer layers of 50 μm, respectively, and a thickness of central layer of 100 μm). Except for having changed into conditions represented in Table 7, in a same manner as in Experiment 12, the undrawn film was drawn to obtain a polyester film No. 21 having a thickness of 50 μm (thicknesses of both outer layers of 12.5 μm, respectively, and a thickness of central layer of 25 μm). Table 8 represents evaluation results of obtained film.

Experiment 22

Except for having changed the ultraviolet radiation cutting agent into TiO₂ (“JR600A” by TAYCA CORP.) having a mean particle diameter of 0.25 μm, and having changed an amount of addition, as represented in Table 6, in a same manner as in Experiment 12, obtained was an undrawn film having a thickness of 260 μm (thicknesses of both outer layers of 50 μm, respectively, and a thickness of central layer of 100 μm). In a same manner as in Experiment 12, this undrawn film was drawn to obtain a polyester film No. 22 having a thickness of 50 μm (thicknesses of both outer layers of 12.5 μm, respectively, and a thickness of central layer of 25 μm) Table 8 represents evaluation results of obtained film.

TABLE 6

| | Polyester mixture | | | | | | | Ultraviolet radiation cutting agent | | |
|---|---|---|---|---|---|---|---|---|---|---|
| Film | composition (mass part) | | | | | | | | Amount of addition (mass %) | |
| number | A | B | C | D | E | F | G | Trade name | Central layer | Both outer layers |
| No. 12 | 15 | 75 | — | 10 | — | — | — | Tinuvin 326 | 1.0 | 1.0 |
| No. 13 | 10 | 80 | — | 10 | — | — | — | Tinuvin 326 | 0.5 | 0.5 |
| No. 14 | 15 | 80 | — | 5 | — | — | — | Tinuvin 326 | 1.0 | 1.0 |
| No. 15 | 15 | — | 75 | 10 | — | — | | Tinuvin 326 | 1.0 | 1.0 |
| No. 16 | — | — | — | 15 | 85 | | — | Bonasorb 3901 | 0.5 | 0.5 |
| No. 17 | 15 | — | — | — | — | 85 | — | Novapex U110 | 30 | 30 |
| No. 18 | 15 | — | 75 | — | — | — | 10 | Tinuvin 326 | 1.0 | 1.0 |
| No. 19 | 15 | 75 | — | 10 | — | — | — | Tinuvin 326 | 1.5 | 0 |
| No. 20 | 40 | — | 50 | 10 | — | — | — | — | 0 | 0 |
| No. 21 | 15 | 75 | — | 10 | — | — | — | — | 0 | 0 |
| No. 22 | 15 | 75 | — | 10 | — | | | TiO₂ | 5 | 5 |

Polyester films No. 12 to No. 22 have a common polyester mixture composition in the central layer and the both outer layers. Accordingly, a column of “polyester mixture composition” in Table 6 represents a polyester mixture composition of all the layers of central layer and both outer layers. In addition, amounts added of the ultraviolet radiation cutting agents in Table 6 represent amounts to 100 mass % of a total amount of the mixed polyester and the ultraviolet radiation cutting agent.

TABLE 7

| | Drawing conditions | | | | | | | |
|---|---|---|---|---|---|---|---|---|
| | First stage | | | | | Second stage | | |
| | of drawing | | Heat setting | | | of drawing | | Tensioning |
| Film | Drawing | Temperature | Tensioning | Temperature | Period | Drawing | Temperature | ratio in |
| number | ratio (time) | (° C.) | ratio (%) | (° C.) | (second) | ratio (time) | (° C.) | cooling (%) |
| No. 12 | 4.75 | 77 | 3 | 77 | 5 | 1.1 | 75 | 1 |
| No. 13 | 4.75 | 77 | 3 | 7 | 5 | 1.1 | 75 | 1 |
| No. 14 | 4.75 | 80 | 3 | 80 | 5 | 1.1 | 78 | 1 |
| No. 15 | 4.75 | 78 | 0 | — | — | 1.1 | 78 | 0 |
| No. 16 | 4.75 | 95 | 3 | 75 | 5 | 1.1 | 75 | 1 |
| No. 17 | 4.75 | 80 | 3 | 75 | 5 | 1.1 | 75 | 1 |
| No. 18 | 4.75 | 77 | 3 | 77 | 5 | 1.1 | 75 | 1 |
| No. 19 | 4.75 | 78 | 3 | 75 | 5 | 1.1 | 75 | 1 |
| No. 20 | 4.75 | 84 | 0 | — | — | 1.1 | 77 | 0 |
| No. 21 | 3.64 | 78 | 0 | — | — | 1.1 | 78 | 0 |
| No. 22 | 4.75 | 77 | 3 | 77 | 5 | 1.1 | 75 | 1 |

In Table 7, A drawing ratio at the time of the first stage of drawing represents a ratio with respect to a film width, a tensioning ratio in the case of heat setting represents a ratio with respect to a film width after the first stage of drawing, a drawing ratio at the time of the second stage of drawing represents a ratio with respect to a film width after heat setting (after the first stage drawing in case of without heat setting), and a tensioning ratio in cooling represents a ratio with respect to a film width after the second stage of drawing. In addition, in films No. 15, 20 and 21, a tensioning ratio “0%” in heat setting represents that heat setting process is not given. A tensioning ratio “0%” at the time of cooling represents that the film is cooled without tensioning after the second stage of drawing.

TABLE 8

| | Heat shrinkage percentage (%) | | | | | |
|---|---|---|---|---|---|---|
| | | (B) | | | Light transmittance (%) | |
| | | Maximum | | Heat shrinkage | Wavelength | |
| Film | | shrinkage | Orthogonal | percentage | of | Wavelength of |
| number | (A) | direction | direction | difference ΔX (%) | 380 nm | 400 nm |
| No. 12 | 30 | 78 | −1 | 10 | 2 | 30 |
| No. 13 | 43 | 78 | −3 | 11 | 13 | 51 |
| No. 14 | 48 | 78 | −3 | 11 | 3 | 30 |
| No. 15 | 30 | 76 | −2 | 15 | 2 | 31 |
| No. 16 | 15 | 76 | 2 | 15 | 1.3 | 0.5 |
| No. 17 | 13 | 76 | −1 | 16 | 0 | 52 |
| No. 18 | 42 | 77 | 1 | 11 | 2 | 30 |
| No. 19 | 30 | 78 | 0 | 10 | 0 | 20 |
| No. 20 | 20 | 70 | 1 | 30 | 81 | 82 |
| No. 21 | 17 | 74 | 8 | 26 | 80 | 82 |
| No. 22 | 28 | 77 | −1 | 13 | 0 | 0 |

| | | Maximum value | | | | |
|---|---|---|---|---|---|---|
| | | of heat | Quality after | Thickness | Melting specific | |
| Film | Haze | shrinkage | shrink- | distribution | resistance | Rate of change in a |
| number | (%) | stress (MPa) | finishing | (%) | (×10⁸ Ω · cm) | bottle diameter (%) |
| No. 12 | 9 | 12 | ∘ | 0.8 | 0.32 | 6.0 |
| No. 13 | 9 | 12 | ∘ | 0.9 | 0.27 | 6.1 |
| No. 14 | 11 | 14 | ∘ | 0.7 | 0.31 | 5.9 |
| No. 15 | 9 | 8 | ∘ | 1.3 | 0.32 | 6.7 |
| No. 16 | 12 | 10 | ∘ | 1.0 | 0.65 | 6.5 |
| No. 17 | 11 | 14 | ∘ | 0.9 | 0.31 | 5.9 |
| No. 18 | 10 | 11 | ∘ | 1.1 | 0.41 | 6.3 |
| No. 19 | 9 | 12 | ∘ | 0.8 | 0.32 | 6.0 |
| No. 20 | 7 | 5 | x | 2.0 | 0.55 | 10.2 |
| No. 21 | 6 | 6 | x | 2.5 | 0.32 | 11.0 |
| No. 22 | 90 | 12 | ∘ | 0.9 | 0.32 | 6.0 |

Light transmittance (%) and haze (%) in Table 8 were measured by following measuring methods. Other physical properties were evaluated by the aforementioned methods.

(11) Light Transmittance

A film was cut into a shape of 38 mm×13 mm, and these cut films were fixed to a double beam spectrophotometer (“U-2001” By Hitachi LTD.) to measure a transmittance of light (ultraviolet radiation) of predetermined wavelengths (380 nm, 400 nm).

(12) Haze

A film was measured for Haze value using an integrating sphere type light transmittance measuring apparatus (“1001DP” by Nippon Denshoku Co., Ltd.) according to JIS K 7105.

Experimental Results about Heat-Shrinkable Polyester Film Roll

### SYNTHESIS EXAMPLE 15

### Synthesis of Polyester

Into an esterification reaction vessel, introduced are dimethyl terephthalate (DMT) 100 mole % as polybasic carboxylic acid, and ethylene glycol (EG) 100 mole % as polyhydric alcohol with 2.2 times (molar ratio) with respect to the polybasic carboxylic acid. Also simultaneously, introduced are antimony trioxide 0.04 mole % with respect to the polybasic carboxylic acid as a catalyst, and magnesium acetate 4 hydrate at 81 ppm in terms of Mg atom with respect to a polyester formed. The system temperature was raised to 230° C., with agitation to perform an ester interchange reaction at normal pressure for 120 minutes. Termination of ester interchange reaction was considered as a timing of a specified quantity of methanol distilled off. After termination of the ester interchange reaction, trimethyl phosphate was added so as to give 58 ppm in terms of P atom with respect to the polyester formed. The system temperature was raised to 280° C., under reduced pressure over 85 minutes, to perform polycondensation reaction approximately for 40 minutes until melt viscosity gives 7000 poise, obtaining a polyester H. An intrinsic viscosity of this polyester H gave 0.75 dl/g. After polymerization, in a molten state, the obtained polyester is removed out from the polymerization apparatus in a shape of a strand, and immediately water-cooled, and subsequently cut with a strand cutter to obtain a raw material chip H.

Intrinsic viscosity was measured at 30±0.1° C. with an Ostwald viscometer. Sample was prepared in such a manner that the chip 0.1 g was precisely weighed, and was dissolved in 25 ml of a mixed solvent of phenol/tetrachloroethane 3/2 (mass ratio).

### SYNTHESIS EXAMPLES 16 TO 23

In a same method as in synthesis example 15, polyester raw material chips I to O were obtained with a preparation composition represented in Table 9. In synthesis examples 16 and 17, polyesters I and J were obtained using antimony trioxide as a polymerization catalyst so that Sb atom might give 160 ppm with respect to a polyester. In addition, in synthesis examples 19 and 23, polyesters K and polyester 0 were obtained using titanium tetrabutoxide as a polymerization catalyst so that Ti atom might give 90 ppm with respect to a polyester. Furthermore, in synthesis example 21, a polyester M was obtained using cobalt acetate tetrahydrate as a polymerization catalyst so that Mg atom might give 20 ppm with respect to a polyester, and furthermore, using titanium tetrabutoxide, so that Ti atoms might give 15 ppm with respect to the polyester. In synthesis examples 20 and 22, a same polymerization catalyst as in synthesis example 15 was used. In chip K and chip O, cutting conditions of chip were changed for a same polyester. The chip O is a chip having smaller shape for comparison. In addition, DMT, DMN, EG, NPG, BD, CHDM, and PPG represent same meanings as described above.

Experiment 23

Each chip obtained in the above-mentioned synthesis examples was separately pre dried. As shown in Table 10, the chip H 15 mass %, the chip 175 mass %, and the chip K 10 mass % chips were mixed in a hopper while being separately delivered continuously with a measuring screw feeder into a hopper disposed over an extruder. Subsequently, the chip obtained was melt extruded with the monoaxial extruder at 280° C., and immediately cooled to obtain an undrawn film having a thickness of 260 μm. Table 10 represents shape differences (%) with respect to the chip I used most. The hopper had an inner capacity of 100 kg of the raw chip, and a discharge amount of the extruder was 450 kg per hour. Furthermore, an inclination angle of the hopper gave 70°. The above-mentioned undrawn film was preheated for 3 seconds at 100° C., and was drawn (a first stage) in a transverse direction 4.75 times at 77° C. by with a tenter. Subsequently, to the film given was 3% of a strain with respect to a film width at the time of termination of the first stage drawing for 5 seconds at 77° C. (heat setting), and then, the film was drawn 1.1 times a film with respect to a width at the time of termination of heat setting (the second stage of drawing) at 75° C. After that, the film was cooled while applying 1% of tension to a film width after termination of drawing of the second stage to continuously form a polyester film with a thickness 50 μm and a length of not less than 1000 m in a roll No. 23. In experiment 23, a range of variation of a film surface temperature at the time of continuous production of the film gave ranges of average temperature ±0.8° C. in the preheating process, average temperature ±0.6° C. in the drawing process, and average temperature ±0.5° C. in the heat treatment process. A surface temperature of the film was measured using a non-contact infrared-type surface thermometer (and so on in following experiments). Tables 12 to 14 represent evaluation results of the obtained film rolls.

Experiment 24

Except for having changed kinds and amounts of used chips into amounts represented in Table 10, for using a hopper giving an angle of inclination of 75°, and for having changed drawing conditions as represented in Table 11, a heat-shrinkable polyester film roll No. 24 was obtained in a same manner as in experiment 23. Tables 12 to 14 represent evaluation results of the obtained film rolls.

Experiments 25 to 29

Except for having changed kinds and amounts of chips used into kinds and amounts as represented in Table 10, and for having changed drawing conditions into conditions as represented in Table 11, heat-shrinkable polyester film rolls No. 25 to 29 were obtained in a same manner as in experiment 23. Tables 12 to 14 represent evaluation results of the obtained film rolls.

Experiment 30

A three layered laminated polyester film roll No. 30 including both outer layers and a central layer was produced. The chip of the polyester H 15 mass %, the chip of the polyester J 75 mass %, and the chip of the polyester K 10 mass % separately pre dried, respectively, were mixed and used for the central layer. In addition, the chip of the polyester H 15 mass %, and the chip of the polyester M 85 mass % separately pre dried, respectively, were mixed and used for both outer layers. These mixed polyester chips were co-extruded at 280° C. using a monoaxial extruder having a T die, and then cooled with casting rolls immediately to obtain a three layered undrawn film with a thickness of 65 μm of both outer layers, respectively, and a thickness of 130 μm of a central layer. Except for having changed into conditions represented in Table 11, this undrawn film was drawn in a same manner as in experiment 23 to obtain a laminated polyester film roll No. 30 with a thickness of 50 μm (a thickness of both outer layers 12.5 μm, respectively, and a thickness of 25 μm of a central layer). Tables 12 and 14 represent evaluation results of the obtained film roll.

Experiment 31

A composition of chips represented in Table 10, that is, the chip H 40 mass %, the chip J 50 mass %, and the chip K 10 mass % were blended beforehand, and then pre dried. Except for having set in series three same-shaped hoppers having a volume of raw material chip of 400 kg, and an angle of inclination of 60°, and for having introduced chip mixture into an upper most stream hopper, and having made the chip mixture move to the second and the third hopper (final hopper), a heat-shrinkable film roll of a heat-shrinkable polyester film with a thickness of 50 μm and a length of 1000 m was obtained in a same manner as in EXAMPLE 1.

Tables 12 to 14 represent evaluation results of the obtained film roll.

Experiment 32

An undrawn film with a thickness of 200 μm was obtained in a same manner as in experiment 23. The undrawn film was preheated for 10 seconds at 100° C., was drawn (a first stage) in a transverse direction 3.64 times at 78° C. by with a tenter, and then, the film was drawn 1.1 times a film with respect to a width at the time of termination of the first stage (a second stage) at 78° C. to continuously form a polyester film with a thickness 50 μm and a length of not less than 1000 m in a roll No. 32. In this experiment 32, a range of variation of a film surface temperature at the time of continuous production of the film gave a range of average temperature ±1.0° C. in the preheating process, average temperature ±2.5° C. in the stretching process, and average temperature ±2.0° C. in the heat treatment process. Tables 12 to 14 represent evaluation results of the obtained film roll.

Experiment 33

A composition of chips represented in Table 10, that is, the chip H 15 mass %, the chip I 75 mass %, and the chip O 10 mass % were blended beforehand, and then pre dried. Except for having set in series three same-shaped hoppers having a volume of raw material chip of 400 kg, and an angle of inclination of 60°, and for having introduced chip mixture into an upper most stream hopper, and having made the chip mixture move to the second and the third hopper (final hopper), obtained was a heat-shrinkable film roll of a heat-shrinkable polyester film with a thickness of 50 μm and a length of 1000 m in a roll No. 33 in a same manner as in Experiment 23. Tables 12 to 14 represent evaluation results of the obtained film roll.

Evaluations of the film rolls were performed by methods as follows.

(13) Steady Region Identification and Setting of Cut-Off Points of Sample

Five samples of film were cut off from a film roll of a 1000 m film prepared in each Experiment at an interval of 20 m from the second end (termination end of winding) thereof, and other five samples were cut off at an interval of 20 m from a position 200 m inside from the first end (initiation end of winding) in the direction to the first end. These samples were measured for heat shrinkage percentage in a maximum shrinkage direction. Variation in the heat shrinkage percentage of the samples was within a range of 20%. Additionally, these films were produced stably both in the film-formation and drawing processes. Thus, it was confirmed that the film in each film roll above corresponded to the steady region over entire length of the film.

In each of following measurement, the first cut-off point of samples was fixed at the second end (0 m from the termination end of winding) of the respective film above, and the final cut-off point was fixed at the first end (0 m from the initiation end of winding), and thus samples for measurement were obtained from 11 cut-off points altogether. Unless otherwise specified in each physical properties measurement, 10 samples were obtained from each of the cut-off points, and an average value of the property determined from the 10 samples was regarded as the property representing the sample at the cut-off point.

(14) Heat Shrinkage Percentage

Films were cut out into a square measuring 10 cm×10 cm at each above-mentioned cut-off point of sample. After being immersed for 5 seconds and heat shrunk in a no-load state in hot water with temperatures of following (a), (b), and (c), each sample was immersed in water at 25° C.±0.5° C. for 10 seconds, and then withdrawn from the water. Each sample was measured for a length in a lengthwise and transverse direction. Heat shrinkage percentage was determined according to following equation.
Heat shrinkage percentage (%)=100×(length before shrinking−length after shrinking)/(length before shrinking)
Here,
(a): 75° C.±0.5° C.,
(b): 85° C.±0.5° C.,
(c): 95° C.±0.5° C.

A direction giving a largest shrinkage percentage was defined as a maximum shrinkage direction, and orthogonal direction to this maximum shrinkage direction was defined as an orthogonal direction. Table 12 represents an average, a maximum, and a minimum of the heat shrinkage percentage of all the films at a temperature of the above (b). In addition, Table 13 represents an average, a maximum, and a minimum of a heat shrinkage percentage of films No. 24, and 31 and 33 at temperatures of (a) and (c). Table 12 and Table 14 represent only average of all the samples of heat shrinkage percentage of other films.

(15) Heat Shrinkage Percentage Difference ΔX

Heat shrinkage percentage differences ΔX (%) according to the method indicated in the above-described (2) were calculated for samples cut from each cut-off point of sample, and Tables 12 and 14 represent averages of all the samples.

(16) Maximum Value of Heat Shrinkage Stress

Maximum values of heat shrinkage stress according to the method indicated in the above-described (4) were calculated for samples cut from each cut-off point of sample, and Tables 12 and 14 represent averages of maximum values of heat shrinkage stress of all the samples.

(17) Thickness Distribution

Thickness distribution was calculated according to the method indicated in the above-described (5) for samples cut from each cut-off point of sample, and then an average of thickness distribution of ten specimens was defined as a thickness distribution of the film in the cut-off point. Table 14 represents averages of thickness distribution in all the cut-off points.

(18) Melting Specific Resistance

Melting specific resistances were calculated by the method indicated in the above-described (6) for samples cut from each cut-off point of sample. Table 14 represents averages of the melting specific resistance in all the cut-off points.

(19) Quality after Shrink-Finishing

Cylindrical label was prepared by the method indicated in the above-described (7). Five cylindrical labels were prepared for every cut-off point of sample. The labels were shrunk according to the method in the above-described (7), and were evaluated for two stages of levels of shrinking finish by visual inspection. Table 14 represents results. Evaluation was performed according to following criteria.

◯: no crinkling, jump, and insufficient shrinkage observed for all labels;

x: crinkling, jump, or insufficient shrinkage observed in one or more labels.

(20) Container Reinforcing Effect (Rate of Change in a Bottle Diameter)

Cylindrical label was prepared by the method in the above-described (8). The label was shrunk according to the method in the above-described (8), and then a load was applied to a central part of a side face of the label-wrapped bottle to calculate a rate of change in a bottle diameter (%) by the above-described equation. Table represents averages of the rate of change in a bottle diameter of all the samples.

TABLE 9

| | Preparation composition | | | | | | | | | |
|---|---|---|---|---|---|---|---|---|---|---|
| | Polybasic | | | | | | | | | |
| | carboxylic | | | | | | | | | |
| | acids | | Polyhydric alcohols | | | | | Shape (average) (mm) | | |
| | (mole %) | | (mole %) | | | | | Section | Section | Chip |
| Polyester | DMT | DMN | EG | NPG | BD | CHDM | PPG | major axis | minor axis | length |
| H | 100 | — | 100 | — | — | — | — | 3.9 | 2.6 | 3.8 |
| I | 100 | — | 60 | 40 | — | — | — | 3.5 | 2.6 | 4.1 |
| J | 100 | — | 70 | 30 | — | — | — | 3.4 | 2.7 | 4.1 |
| K | 100 | — | — | — | 100 | — | — | 3.6 | 2.9 | 3.6 |
| L | — | 100 | 100 | — | — | — | — | 3.8 | 2.6 | 3.8 |
| M | 100 | — | 70 | — | — | 30 | — | 3.5 | 2.6 | 4.0 |
| N | 100 | — | — | — | — | — | 100 | 3.6 | 2.8 | 3.6 |
| O | 100 | — | — | — | 100 | — | — | 2.7 | 2.0 | 3.2 |

TABLE 10

| | | | | | | | | | | | Average shape difference | | |
|---|---|---|---|---|---|---|---|---|---|---|---|---|---|
| | | | | | | | | | | | of raw material chip (%) | | |
| Film | | | Polyester mixture | | | | | | | | Section | Section | |
| roll | Composition of | | composition (mass %) | | | | | | | | major | minor | Chip |
| number | layer | | H | I | J | K | L | M | N | O | axis | axis | length |
| No. 23 | Single layer | | 15 | 75 | — | 10 | — | — | — | — | 11.4 | 11.5 | −12.2 |
| No. 24 | Single layer | | 10 | 80 | — | 10 | — | — | — | — | 11.4 | 11.5 | −12.2 |
| No. 25 | Single layer | | 15 | 80 | — | 5 | — | — | — | — | 11.4 | 11.5 | −12.2 |
| No. 26 | Single layer | | 15 | — | 75 | 10 | — | — | — | — | 14.7 | 7.4 | −12.2 |
| No. 27 | Single layer | | — | — | — | 15 | 85 | — | — | — | −5.3 | 11.5 | −5.3 |
| No. 28 | Single layer | | 15 | — | — | — | — | 85 | — | — | 11.4 | 0 | −5.0 |
| No. 29 | Single layer | | 15 | — | 75 | — | — | — | 10 | — | 11.4 | 7.7 | 12.2 |
| No. 30 | Three- | Central | 15 | — | 75 | 10 | — | — | | — | 14.7 | 7.4 | −12.2 |
| | layered | layer | | | | | | | | | | | |
| | | Both | 15 | — | — | — | — | 85 | | — | 11.4 | 0 | −5.0 |
| | | outer | | | | | | | | | | | |
| | | layers | | | | | | | | | | | |

| | | | | | | | | | | | | |
|---|---|---|---|---|---|---|---|---|---|---|---|---|
| No. 31 | Single layer | 40 | — | 50 | 10 | — | — | — | — | 11.4 | 11.5 | −12.2 |
| No. 32 | Single layer | 15 | 75 | — | 10 | — | — | — | — | 11.4 | 11.5 | −12.2 |
| No. 33 | Single layer | 15 | 75 | — | — | — | — | — | 10 | 21.0 | 21.5 | 21.0 |

TABLE 11

| | | Drawing conditions | | | | | | | |
|---|---|---|---|---|---|---|---|---|---|
| | | First stage of | | | | | Second stage of | | |
| | Angle of | drawing | | Heat setting | | | drawing | | Tensioning |
| Film | inclination | Drawing | | | | Period | Drawing | | ratio in |
| roll | of hopper | ratio | Temperature | Tensioning | Temperature | of time | ratio | Temperature | cooling |
| number | (°) | (time) | (° C.) | ratio (%) | (° C.) | (second) | (time) | (° C.) | (%) |
| No. 23 | 70 | 4.75 | 77 | 3 | 77 | 5 | 1.1 | 75 | 1 |
| No. 24 | 75 | 4.75 | 77 | 3 | 77 | 5 | 1.1 | 75 | 1 |
| No. 25 | 70 | 4.75 | 80 | 3 | 80 | 5 | 1.1 | 78 | 1 |
| No. 26 | 70 | 4.75 | 78 | 0 | — | — | 1.1 | 78 | 0 |
| No. 27 | 70 | 4.75 | 95 | 3 | 75 | 5 | 1.1 | 75 | 1 |
| No. 28 | 70 | 4.75 | 80 | 3 | 75 | 5 | 1.1 | 75 | 1 |
| No. 29 | 70 | 4.75 | 77 | 3 | 77 | 5 | 1.1 | 75 | 1 |
| No. 30 | 70 | 4.75 | 78 | 3 | 75 | 5 | 1.1 | 75 | 1 |
| No. 31 | 60 | 4.75 | 84 | 0 | — | — | 1.1 | 77 | 0 |
| No. 32 | 70 | 3.64 | 78 | 0 | — | — | 1.1 | 78 | 0 |
| No. 33 | 60 | 4.75 | 77 | 3 | 77 | 5 | 1.1 | 75 | 1 |

TABLE 12

| | Heat shrinkage percentage (%) | | | | | | | | |
|---|---|---|---|---|---|---|---|---|---|
| | (a) 70° C. | (b) 85° C. | | | Heat shrinkage percentage (b) | | | | |
| Film | Maximum | Maximum | | | maximum shrinkage direction (%) | | | | |
| roll | shrinkage | shrinkage | orthogonal | (c) ΔX | Average | Maximum | Minimum | | |
| number | direction | direction | direction | at 95° C. | (Q) | (Rmax) | (Rmin) | Rmax − Q | Rmin − Q |
| No. 23 | 30 | 78 | −1 | 10 | 78.0 | 79.0 | 77.0 | 1.0 | 1.0 |
| No. 24 | 43 | 78 | −3 | 11 | 78.0 | 79.0 | 77.0 | 1.0 | 1.0 |
| No. 25 | 48 | 78 | −3 | 11 | 78.0 | 79.0 | 77.0 | 1.0 | 1.0 |
| No. 26 | 30 | 76 | −2 | 15 | 76.3 | 77.5 | 75.3 | 1.2 | 1.0 |
| No. 27 | 15 | 76 | 2 | 15 | 76.0 | 77.3 | 75.3 | 1.3 | 0.7 |
| No. 28 | 13 | 76 | −1 | 16 | 76.0 | 77.0 | 75.3 | 1.0 | 0.7 |
| No. 29 | 42 | 77 | 1 | 11 | 77.0 | 78.0 | 76.0 | 1.0 | 1.0 |
| No. 30 | 45 | 78 | 0 | 10 | 78.0 | 79.0 | 77.0 | 1.0 | 1.0 |
| No. 31 | 20 | 69 | 1 | 30 | 68.8 | 74.3 | 61.8 | 5.5 | 7.0 |
| No. 32 | 17 | 69 | 8 | 26 | 69.2 | 74.5 | 63.0 | 5.3 | 6.2 |
| No. 33 | 31 | 78 | −1 | 11 | 78.0 | 79.0 | 72.5 | 1.0 | 5.5 |

TABLE 13

| | Heat shrinkage percentage (a) | | | | | Heat shrinkage percentage | | | | |
|---|---|---|---|---|---|---|---|---|---|---|
| Film | maximum shrinkage direction (%) | | | | | difference ΔX (c) (%) | | | | |
| roll | Average | Maximum | Minimum | | | Average | Maximum | Minimum | | |
| number | (Q) | (Rmax) | (Rmin) | Rmax − Q | Rmin − Q | (Q) | (Rmax) | (Rmin) | Rmax − Q | Rmin − Q |
| No. 24 | 43.0 | 45.5 | 40.0 | 2.5 | 3.0 | 11.0 | 12.0 | 10.0 | 1.0 | 1.0 |
| No. 31 | 20.0 | 26.0 | 13.5 | 6.0 | 6.5 | 30.0 | 36.0 | 26.5 | 6.0 | 6.5 |
| No. 33 | 31.0 | 36.5 | 24.0 | 5.5 | 6.0 | 11.0 | 21.0 | 10.0 | 10.0 | 1.0 |

TABLE 14

| | Maximum value | | | Melting | Rate of |
|---|---|---|---|---|---|
| | of heat | | Thickness | specific | change in |
| Film roll | shrinkage | Quality after | distribution | resistance | bottle |
| number | stress (MPa) | shrink-finishing | (%) | (×10⁸ Ω · cm) | diameter (%) |
| No. 23 | 12 | ∘ | 0.8 | 0.32 | 6.0 |
| No. 24 | 12 | ∘ | 0.9 | 0.27 | 6.1 |
| No. 25 | 14 | ∘ | 0.7 | 0.31 | 5.9 |
| No. 26 | 8 | ∘ | 1.3 | 0.32 | 6.7 |
| No. 27 | 10 | ∘ | 1.0 | 0.65 | 6.5 |
| No. 28 | 14 | ∘ | 0.9 | 0.31 | 5.9 |
| No. 29 | 11 | ∘ | 1.1 | 0.41 | 6.3 |
| No. 30 | 12 | ∘ | 1.0 | 0.32 | 6.0 |
| No. 31 | 5 | x | 2.0 | 0.55 | 10.2 |
| No. 32 | 4 | x | 2.5 | 0.32 | 11.0 |
| No. 33 | 12 | x | 1.5 | 0.32 | 10.2 |

As is clear from Tables 12 to 14, the film rolls No. 31 and 33, obtained by a long film production through a plurality of hoppers having smaller angles of inclination, or using smaller chips in comparative example, caused raw material uneven supply and gave larger variation of heat shrinkage percentage. As a result, defective products had occurred in quality after shrink-finishing. In addition, the film roll No. 32 without strict temperature control in drawing process exhibited variation in heat shrinkage percentage. On the other hand, in the present invention Examples (film rolls No. 23 to 30), use of uniform chip size did not cause raw material uneven supply, gave little variation in heat shrinkage properties, and successfully exhibited all excellent properties.

1. A heat-shrinkable polyester film satisfying following requirements (A) to (E):
(A) a heat shrinkage percentage in a maximum shrinkage direction of a sample is 10% to 50%,
wherein, the sample is prepared and treated under following conditions:
a heat-shrinkable polyester film is cut into a shape of a square measuring 10 cm×10 cm;
the sample obtained is immersed in hot water at 70° C. for 5 seconds and then withdrawn from the hot water, and subsequently is immersed in water at 25° C. for 10 seconds, and then withdrawn from the water;
(B) a heat shrinkage percentage of a sample in a maximum shrinkage direction is not less than 75%, and a heat shrinkage percentage in a direction orthogonal to the maximum shrinkage direction is not more than 10%,
wherein, the sample is prepared and treated under following conditions:
a heat-shrinkable polyester film is cut into a shape of a square measuring 10 cm×10 cm;
the sample obtained is immersed in hot water at 85° C. for 5 seconds and then withdrawn from the hot water, and subsequently is immersed in water at 25° C. for 10 seconds, and then withdrawn from the water;
(C) a heat shrinkage percentage difference of a sample ΔX (%) represented by a following equation is 10% to 20%,
ΔX=X₀−X₁₀
wherein, X₀ and X₁₀ are defined as follows;
X₀: a heat shrinkage percentage in a maximum shrinkage direction of a sample obtained by cutting a heat-shrinkable polyester film into a shape of a square measuring 10 cm×10 cm;
X₁₀: a heat shrinkage percentage in a maximum shrinkage direction of a film obtained by cutting a heat-shrinkable polyester film having experienced heat shrink by 10% in a maximum shrinkage direction; and
wherein, the sample obtained is immersed in hot water at 95° C. for 5 seconds and then withdrawn from the hot water, and subsequently is immersed in water at 25° C. for 10 seconds, and then withdrawn from the water;
(D) a three-dimensional surface roughness SΔa is 0.008 to 0.04;
(E) a three-dimensional surface roughness SRz is 0.6 to 1.5 μm.

2. A heat-shrinkable polyester film satisfying following requirements (A) to (C), (F) (G):
(A) a heat shrinkage percentage in a maximum shrinkage direction of a sample is 10% to 50%,
wherein, the sample is prepared and treated under following conditions:
a heat-shrinkable polyester film is cut into a shape of a square measuring 10 cm×10 cm;
the sample obtained is immersed in hot water at 70° C. for 5 seconds and then withdrawn from the hot water, and subsequently is immersed in water at 25° C. for 10 seconds, and then withdrawn from the water;
(B) a heat shrinkage percentage of a sample in a maximum shrinkage direction is not less than 75%, and a heat shrinkage percentage in a direction orthogonal to the maximum shrinkage direction is not more than 10%,
wherein, the sample is prepared and treated under following conditions:
a heat-shrinkable polyester film is cut into a shape of a square measuring 10 cm×10 cm;
the sample obtained is immersed in hot water at 85° C. for 5 seconds and then withdrawn from the hot water, and subsequently is immersed in water at 25° C. for 10 seconds, and then withdrawn from the water;
(C) a heat shrinkage percentage difference of a sample ΔX (%) represented by a following equation is 10% to 20%,
ΔX=X₀−X₁₀
wherein, X₀ and X₁₀ are defined as follows;
X₀: a heat shrinkage percentage in a maximum shrinkage direction of a sample obtained by cutting a heat-shrinkable polyester film into a shape of a square measuring 10 cm×10 cm;
X₁₀: a heat shrinkage percentage in a maximum shrinkage direction of a film obtained by cutting a heat-shrinkable polyester film having experienced heat shrink by 10% in a maximum shrinkage direction; and
wherein, the sample obtained is immersed in hot water at 95° C. for 5 seconds and then withdrawn from the hot water, and subsequently is immersed in water at 25° C. for 10 seconds, and then withdrawn from the water;
(F) a light transmission at a wavelength of 380 nm is not more than 20%, and a light transmission at a wavelength of 400 nm is not more than 60%;
(G) a Haze value is not more than 15%.

3. A film roll of a heat-shrinkable polyester film having a length of 1000 to 6000 m, the heat-shrinkable polyester film satisfying following requirements (a) to (c):
(a) an average of heat shrinkage percentages in a maximum shrinkage direction of samples is 10% to 50%,
wherein, the samples are obtained in a following manner: an initiation end of winding of a film of steady region giving stable film properties in a longitudinal direction is defined as a first end, and a termination end of winding thereof is defined as a second end;
a first cut-off point of the samples of the film is provided less than 2 m inside of the second end, and a final cut-off point is provided less than 2 m inside the first end;
a plurality of sample cut-off points are provided at an interval of about 100 m from the first cut-off point, and the samples are obtained by cutting into a shape of a square measuring 10 cm×10 cm at each sample cut-off point; and
wherein the samples are treated in a following manner: the samples obtained are immersed in hot water at 70° C. for 5 seconds and then withdrawn from the hot water, and subsequently immersed in water at 25° C. for 10 seconds, and then withdrawn from the water;
(b) an average of heat shrinkage percentages in a maximum shrinkage direction of samples is not less than 75%, and a heat shrinkage percentage in a direction orthogonal to the maximum shrinkage direction is not more than 10%,
wherein, the samples are treated in a following manner:
each sample in a shape of a square measuring 10 cm×10 cm is separately cut from each cut-off point of sample in the requirement (a);
the obtained samples are immersed in hot water at 85° C. for 5 seconds, and then withdrawn from the hot water, and subsequently, immersed in water at 25° C. for 10 seconds, and then withdrawn from the water; and
(c) a heat shrinkage percentage difference ΔX (%) of samples at all cut-off points of samples represented by following equation is in a range of 10% to 20%,
ΔX=X₀−X₁₀
wherein, X₀ and X₁₀ are defined as follows,
X₀: a heat shrinkage percentage in a maximum shrinkage direction measured for each sample in a shape of a square measuring 10 cm×10 cm separately cut from each cut-off point of sample in the requirement (a) being immersed for 5 seconds in hot water at 95° C., then withdrawn from the hot water, and subsequently, being immersed in water at 25° C. for 10 seconds, and then withdrawn from the water;
X₁₀: a heat shrinkage percentage in a maximum shrinkage direction measured in a same manner for each sample obtained by cutting into a shape of a square measuring 10 cm×10 cm after shrunk by 10% in a maximum shrinkage direction of a cut sample in a shape of a square measuring 25 cm×25 cm separately cut from each cut-off point of sample in the requirement (a).
